(19) United States
(12) Patent Application Publication
(10) Pub. No.: US 2026/0106411 A1
(43) Pub. Date: Apr. 16, 2026

(54) FIRST TERMINAL MODULE AND FIRST BACKPLANE CONNECTOR WITH IMPROVED EXTENSION SHIELDING SHELL ASSEMBLY AND ELASTIC PIECE

(71) Applicant: DONGGUAN LUXSHARE TECHNOLOGIES CO., LTD, Dongguan City (CN)

(72) Inventors: Tao SONG, Dongguan City (CN); Kun LIU, Dongguan City (CN); Feng ZHENG, Dongguan City (CN); Xingyu LI, Dongguan City (CN); Jinchuang LAN, Dongguan City (CN); Yuanxin WANG, Dongguan City (CN); Zhongfan GOU, Dongguan City (CN)

(73) Assignee: DONGGUAN LUXSHARE TECHNOLOGIES CO., LTD, Dongguan City (CN)

(21) Appl. No.: 18/929,788

(22) Filed: Oct. 29, 2024

(30) Foreign Application Priority Data
Oct. 11, 2024 (CN) 202411421669.8

(51) Int. Cl. H01R 13/6584; H01R 12/71; H01R 13/20; H01R 13/514; H01R 13/518; H01R 13/6474; H01R 13/652; H01R 13/6587; H01R 13/6591

(52) U.S. Cl. CPC H01R 13/6584; H01R 13/20; H01R 13/514; H01R 13/6587; H01R 13/6591; H01R 12/716; H01R 13/518; H01R 13/6474; H01R 13/652

(57) ABSTRACT

A first terminal module includes a first cable module and an extension shielding shell assembly. The first cable module includes a number of first conductive terminals and a first cable connected to the first conductive terminals. The extension shielding shell assembly includes a first extension shielding piece, a second extension shielding piece, a first connection shielding piece, a second connection shielding piece and at least one elastic piece. The first extension shielding piece, the second extension shielding piece, the first connection shielding piece and the second connection shielding piece together form a shielding chamber. The elastic piece protrudes into the shielding chamber. The present disclosure is beneficial to improving the shielding effect on the first conductive terminal. A first backplane connector having the first terminal module is also disclosed.

### CROSS-REFERENCE TO RELATED APPLICATION

This patent application claims priority of a Chinese Patent Application No. 202411421669.8, filed on Oct. 11, 2024 and titled “FIRST TERMINAL MODULE AND FIRST BACKPLANE CONNECTOR”, the entire content of which is incorporated herein by reference.

### TECHNICAL FIELD

The present disclosure relates to a first terminal module and a first backplane connector, which belongs to the technical field of connectors.

### BACKGROUND

Existing backplane connectors usually include an insulating housing and a plurality of terminal modules mounted to the insulating housing. Each terminal module includes a plurality of conductive terminals and a plurality of cables connected to the conductive terminals. The plurality of conductive terminals typically include pairs of differential signal terminals.

However, there is still room for improvement in the terminal shielding structure in the prior art.

### SUMMARY

An object of the present disclosure is to provide a first terminal module and a first backplane connector with improved extension shielding shell assembly and elastic piece to perform the shielding effect.

In order to achieve the above object, the present disclosure adopts the following technical solution: a first terminal module, including: a first cable module, the first cable module including a plurality of first conductive terminals and a first cable connected to the first conductive terminals; the first conductive terminals including a first signal terminal and a second signal terminal; each of the first signal terminal and the second signal terminal including a first contact portion; and an extension shielding shell assembly, the extension shielding shell assembly including: a first extension shielding piece; a second extension shielding piece disposed opposite to the first extension shielding piece; a first connection shielding piece; a second connection shielding piece disposed opposite to the first connection shielding piece; and at least one elastic piece, the at least one elastic piece being fixed to at least one of the first extension shielding piece, the second extension shielding piece, the first connection shielding piece and the second connection shielding piece; wherein the first extension shielding piece, the second extension shielding piece, the first connection shielding piece and the second connection shielding piece jointly form a shielding chamber; the first contact portion of the first signal terminal and the first contact portion of the second signal terminal protrudes into the shielding cavity of the extension shielding shell assembly; the elastic piece protrudes into the shielding chamber.

In order to achieve the above object, the present disclosure adopts the following technical solution: a first backplane connector, including: a first housing; and a first terminal module mounted to the first housing; the first terminal module including: a first cable module, the first cable module including a plurality of first conductive terminals and a first cable connected to the first conductive terminals; the first conductive terminals including a first signal terminal and a second signal terminal; each of the first signal terminal and the second signal terminal including a first contact portion; and an extension shielding shell assembly, the extension shielding shell assembly including: a first extension shielding piece; a second extension shielding piece disposed opposite to the first extension shielding piece; a first connection shielding piece; a second connection shielding piece disposed opposite to the first connection shielding piece; and at least one elastic piece, the at least one elastic piece being fixed to at least one of the first extension shielding piece, the second extension shielding piece, the first connection shielding piece and the second connection shielding piece; wherein the first extension shielding piece, the second extension shielding piece, the first connection shielding piece and the second connection shielding piece jointly form a shielding chamber; the first contact portion of the first signal terminal and the first contact portion of the second signal terminal protrudes into the shielding cavity of the extension shielding shell assembly; the elastic piece protrudes into the shielding chamber.

Compared with the prior art, the first terminal module and the first backplane connector of the present disclosure both include a first cable module and an extension shielding shell assembly. The first cable module includes a plurality of first conductive terminals and a first cable electrically connected to the first conductive terminals. The extension shielding shell assembly includes a shielding chamber and at least one elastic piece protruding into the shielding chamber. With this arrangement, the present disclosure is beneficial to improving the shielding effect on the first conductive terminal.

### BRIEF DESCRIPTION OF DRAWINGS

FIG. 1 is a schematic perspective view of a backplane connector assembly in accordance with a first embodiment of the present disclosure, in which a first backplane connector and a second backplane connector are in a mating state;

FIG. 2 is a partially exploded perspective view of FIG. 1, in which the first backplane connector and the second backplane connector are separated from each other;

FIG. 3 is a partially exploded perspective view of FIG. 2 from another angle;

FIG. 4 is a right view of FIG. 3;

FIG. 5 is a partially exploded perspective view of the first backplane connector in accordance with the first embodiment of the present disclosure, in which a first housing is separated;

FIG. 6 is a partially exploded perspective view of FIG. 5 from another angle;

FIG. 7 is a partially exploded perspective view of the first backplane connector in accordance with the first embodiment of the present disclosure, in which a retaining block is separated;

FIG. 8 is a partially exploded perspective view of FIG. 7 from another angle;

FIG. 9 is a partially exploded perspective view of the first backplane connector in accordance with the first embodiment of the present disclosure, in which a first terminal module is separated;

FIG. 10 is a partially exploded perspective view of FIG. 9 from another angle;

FIG. 11 is a partially exploded perspective view of the first terminal module in FIG. 9, with an extension shielding shell assembly being separated;

FIG. 12 is a partially exploded perspective view of FIG. 11 from another angle;

FIG. 13 is a partial enlarged view of frame part B in FIG. 11;

FIG. 14 is a partial enlarged view of frame part C in FIG. 12;

FIG. 15 is a front view of the extension shielding shell assembly of FIG. 11;

FIG. 16 is a partial enlarged view of frame portion D in FIG. 15;

FIG. 17 is a partially exploded perspective view of the extension shielding shell assembly of FIG. 11;

FIG. 18 is a partially exploded perspective view of FIG. 17 from another angle;

FIG. 19 is a perspective view of the partially extension shielding shell assembly in FIG. 17;

FIG. 20 is a perspective view of FIG. 19 from another angle;

FIG. 21 is a right side view of the partially extension shielding shell assembly of FIG. 17;

FIG. 22 is an exploded view of the partially extension shielding shell assembly of FIG. 21;

FIG. 23 is a partially exploded perspective view of a first terminal module in FIG. 11 after removing the extension shielding shell assembly, in which a first shielding sleeve is separated;

FIG. 24 is a partial enlarged view of frame part E in FIG. 23;

FIG. 25 is a partially exploded perspective view of FIG. 23 from another angle;

FIG. 26 is a partially exploded perspective view of the first terminal module in FIG. 11, in which a first metal shielding plate, a second metal shielding plate and a plurality of first shielding sleeves are separated;

FIG. 27 is a partially exploded perspective view of FIG. 26 from another angle;

FIG. 28 is a side view of an insulating bracket, a plurality of first conductive terminals and a plurality of first shielding sleeves of the first terminal module in FIG. 11 after removing the first metal shielding plate and the second metal shielding plate;

FIG. 29 is a perspective view of the second backplane connector in accordance with the first embodiment of the present disclosure in FIG. 2;

FIG. 30 is a partially exploded perspective view of FIG. 29, in which a second housing is separated;

FIG. 31 is a partially exploded perspective view of FIG. 30 from another angle;

FIG. 32 is a rear view of FIG. 29;

FIG. 33 is a front view of FIG. 29;

FIG. 34 is a partially exploded view of FIG. 33;

FIG. 35 is a partially exploded perspective view of the second backplane connector of the present disclosure;

FIG. 36 is a partially exploded perspective view of FIG. 35 from another angle;

FIG. 37 is a perspective view of a second terminal module of the second backplane connector of the present disclosure;

FIG. 38 is a perspective view of FIG. 37 from another angle;

FIG. 39 is a partially exploded perspective view of FIG. 37;

FIG. 40 is a partially exploded perspective view of FIG. 39 from another angle;

FIG. 41 is a partially exploded perspective view of a second cable module in FIG. 40;

FIG. 42 is a partially exploded perspective view of FIG. 41 from another angle;

FIG. 43 is a further partially exploded perspective view of FIG. 41;

FIG. 44 is a partially exploded perspective view of FIG. 43 from another angle;

FIG. 45 is a further partial perspective exploded view of the second cable module after removing a second shielding sleeve and a second insulating block in FIG. 43;

FIG. 46 is a partially exploded perspective view of FIG. 45 from another angle;

FIG. 47 is a perspective view of a set of second conductive terminals in FIG. 45;

FIG. 48 is a perspective view of FIG. 47 from another angle;

FIG. 49 is a perspective view of FIG. 47 from yet another angle;

FIG. 50 is a top view of FIG. 49;

FIG. 51 is a schematic perspective view of the first terminal module of the first backplane connector mated with the second terminal module of the second backplane connector in accordance with the first embodiment of the present disclosure;

FIG. 52 is a schematic perspective view of the first terminal module in FIG. 51 after removing the first extension shielding piece and the second extension shielding piece;

FIG. 53 is a right view of FIG. 52;

FIG. 54 is a partial enlarged view of frame part F in FIG. 53;

FIG. 55 is a partially exploded perspective view of FIG. 52, in which the first terminal module and the second terminal module are separated from each other;

FIG. 56 is a partial enlarged view of frame portion H in FIG. 55;

FIG. 57 is a perspective view of the first terminal module in FIG. 55 from another angle;

FIG. 58 is a partial enlarged view of frame part I in FIG. 57;

FIG. 59 is a perspective view of the first terminal module in FIG. 55 from another angle;

FIG. 60 is a partial enlarged view of frame portion J in FIG. 59;

FIG. 61 is a partially exploded perspective view of the first backplane connector in accordance with a second embodiment of the present disclosure;

FIG. 62 is a right view after removing a retaining block and a circuit board in FIG. 61;

FIG. 63 is a partially exploded view of FIG. 62 with a mounting block separated;

FIG. 64 is an exploded schematic view of an insulating bracket and a plurality of first conductive terminals in FIG. 63;

FIG. 65 is a schematic cross-sectional view of the first backplane connector along a certain section in accordance with the second embodiment of the present disclosure;

FIG. 66 is a partial enlarged view of frame part K in FIG. 65;

FIG. 67 is a partial enlarged view of frame portion L in FIG. 66, in which a first tail portion of the first signal terminal and a first tail portion of the second signal terminal are not fully installed in place to the circuit board;

FIG. 68 is a schematic view of another state of FIG. 67, in which the first tail portion of the first signal terminal and the first tail portion of the second signal terminal are installed to the circuit board and are installed in place;

FIG. 69 is a schematic perspective view of the first backplane connector assembly in accordance with a third embodiment of the present disclosure, in which the first backplane connector and the second backplane connector are in a mating state;

FIG. 70 is a partially exploded perspective view of FIG. 69, in which the first backplane connector and the second backplane connector are separated from each other;

FIG. 71 is a partially exploded perspective view of the first backplane connector in accordance with the third embodiment of the present disclosure;

FIG. 72 is a partially exploded perspective view of FIG. 71 from another angle;

FIG. 73 is a partially exploded perspective view of a first terminal module of the first backplane connector in accordance with the third embodiment of the present disclosure, in which an extension shielding shell assembly is separated;

FIG. 74 is a partially exploded perspective view of FIG. 73 from another angle;

FIG. 75 is a further partially exploded perspective view of FIG. 73;

FIG. 76 is a partially exploded perspective view of FIG. 75 from another angle;

FIG. 77 is an exploded perspective view of a first cable module in FIG. 75; and

FIG. 78 is an exploded perspective view of FIG. 77 from another angle.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

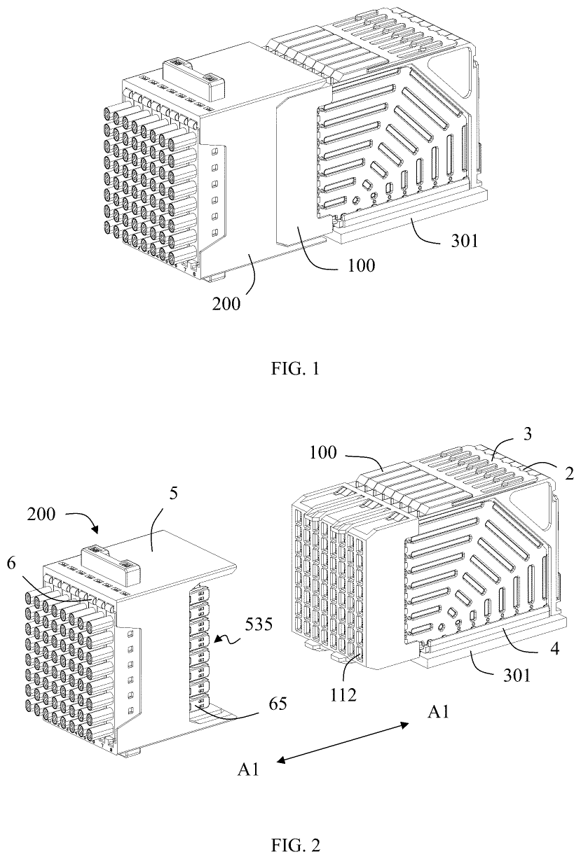

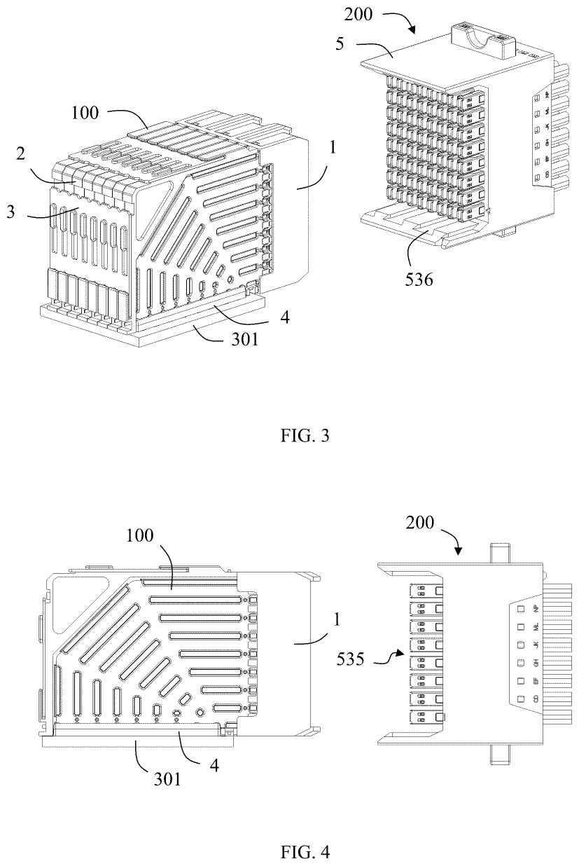

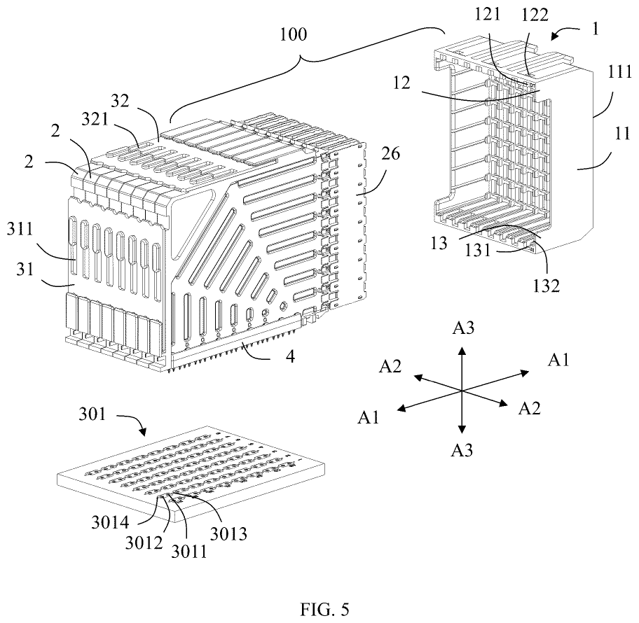

The present disclosure discloses a connector assembly, which includes a first connector and a second connector for mating with the first connector. The first connector and/or the second connector are both called connectors. Referring to FIGS. 1 to 4, in a first embodiment of the present disclosure, the connector assembly is a backplane connector assembly, which includes a first backplane connector 100, a second backplane connector 200 for mating with the first backplane connector 100, and a circuit board 301 mounted with the first backplane connector 100. The first backplane connector 100 is one of a board-end backplane connector and a cable backplane connector. The second backplane connector 200 is one of a cable backplane connector and a board-end backplane connector. In the first illustrated embodiment of the present disclosure, the first backplane connector 100 is a board-end backplane connector, and the second backplane connector 200 is a cable backplane connector. Of course, it is understandable to those skilled in the art that the first backplane connector 100 and the second backplane connector 200 can be combined in various forms, as long as they can be mated with each other. Referring to FIG. 1 and FIG. 2, in the illustrated embodiment of the present disclosure, the first backplane connector 100 and the second backplane connector 200 are mated along a first direction A1-A1 (i.e., a mating direction) to achieve signal transmission. In the illustrated embodiment of the present disclosure, the first direction A1-A1 is a front-back direction.

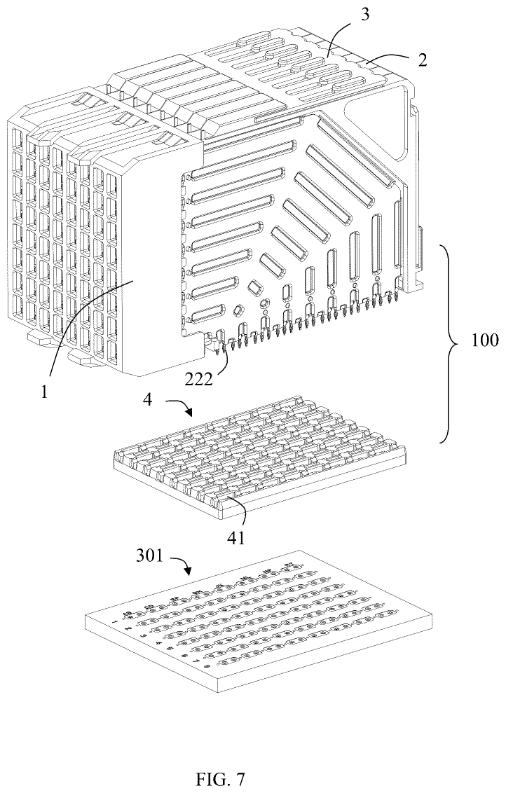

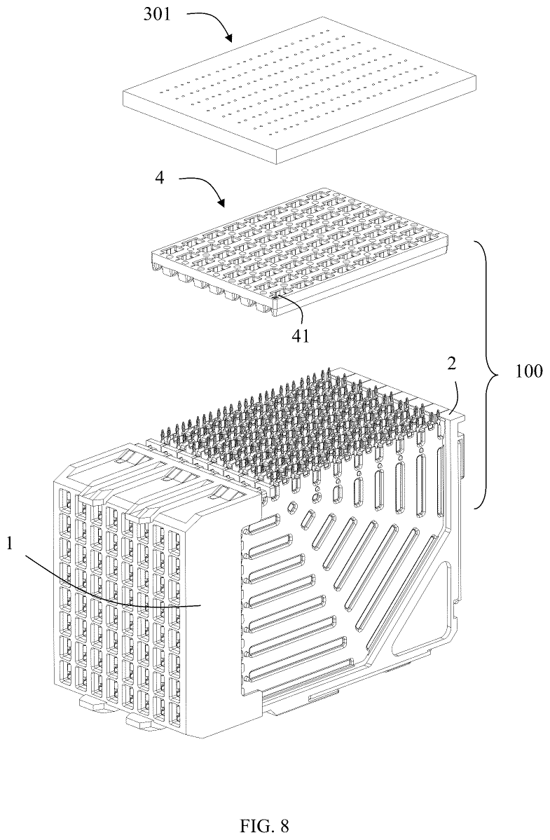

As shown in FIG. 7 and FIG. 8, in the first embodiment of the present disclosure, the circuit board 301 defines a plurality of first signal terminal mounting holes 3011, a plurality of second signal terminal mounting holes 3012, a plurality of first ground terminal mounting holes 3013 and a plurality of second ground terminal mounting holes 3014. In the illustrated embodiment of the present disclosure, the plurality of first signal terminal mounting holes 3011, the plurality of second signal terminal mounting holes 3012, the plurality of first ground terminal mounting holes 3013 and the plurality of second ground terminal mounting holes 3014 are arranged in matrix. The first signal terminal mounting hole 3011 and the second signal terminal mounting hole 3012, which are disposed adjacent to each other along the first direction A1-A1, form a group of signal differential pair terminal mounting holes. Each pair of signal differential pair terminal mounting holes are associated with one first ground terminal mounting hole 3013 and one second ground terminal mounting hole 3014 which are disposed at two ends of the pair of signal differential pair terminal mounting holes in order to improve the quality of signal transmission. In the first embodiment of the present disclosure, the first signal terminal mounting holes 3011, the second signal terminal mounting holes 3012, the first ground terminal mounting holes 3013 and the second ground terminal mounting holes 3014 are conductive holes. That is, a conductive material (for example, metal) is formed on an inner wall of each conductive hole. When a tail portion of a conductive terminal contacts the conductive material, electrical conduction can be established with the circuit board 301. As for the shape, size and whether the conductive holes extend through the circuit board 301, etc., they can be flexibly designed according to needs, which will not be described in detail in the present disclosure.

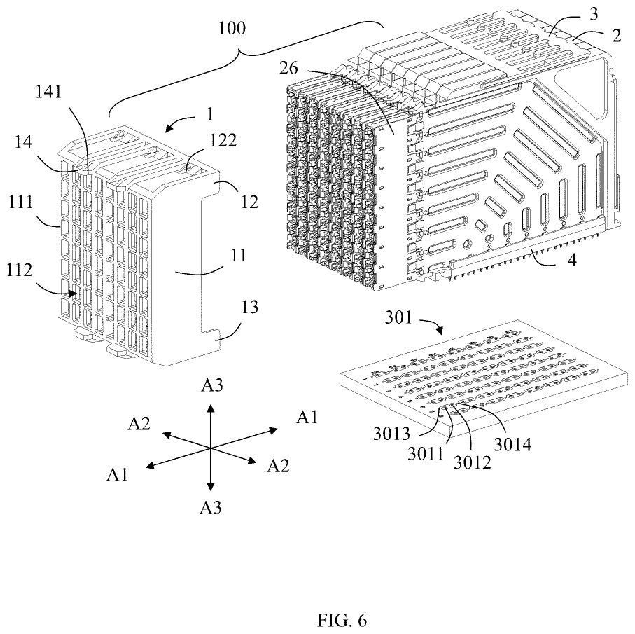

Referring to FIG. 5 and FIG. 6, the first backplane connector 100 includes a first housing 1, a plurality of first terminal modules 2 mounted to the first housing 1, a plurality of holding pieces 3 for holding the plurality of first terminal modules 2 together, and a retaining block 4 held at the bottom ends of the plurality of first terminal modules 2.

In an embodiment of the present disclosure, the first housing 1 is made of insulating material and includes a first body portion 11, a first wall portion 12 extending backwardly from one side (for example, an upper side) of the first body portion 11, and a second wall portion 13 extending backwardly from another side (for example, a lower side) of the first body portion 11. The first body portion 11 is provided with a mating surface 111 and a plurality of terminal receiving grooves 112 extending through the mating surface 111. In the illustrated embodiment of the present disclosure, the terminal receiving grooves 112 are arranged in multiple rows along a third direction A3-A3 (for example, a top-bottom direction), and are arranged in multiple columns along a second direction A2-A2 (for example, a left-right direction). Each two of the first direction A1-A1, the second direction A2-A2 and the third direction A3-A3 are perpendicular to each other. The first wall portion 12 defines a plurality of first insertion slots 121 and a plurality of first locking grooves 122 communicating with the first insertion slots 121. The second wall portion 13 defines a plurality of second insertion slots 131 and a plurality of second locking grooves 132 communicating with the second insertion slots 131. The first locking grooves 122 and the second locking grooves 132 extend through the first wall portion 12 and the second wall portion 13 outward along the third direction A3-A3, respectively, for locking the first terminal modules 2, so that the first terminal modules 2 are prevented from being separated from the first housing 1. The first insertion slot 121, the second insertion slot 131 and the terminal receiving grooves 112 that are aligned with each other are used to receive a single first terminal module 2.

Besides, referring to FIG. 6, the first housing 1 further includes a plurality of positioning protrusions 14 extending forwardly from the first wall portion 12 and the second wall portion 13, respectively, and protruding beyond the mating surface 111. Each positioning protrusion 14 includes a guide inclined surface 141 at an end thereof. The positioning protrusion 14 is configured to be inserted into a positioning groove 536 of the second backplane connector 200.

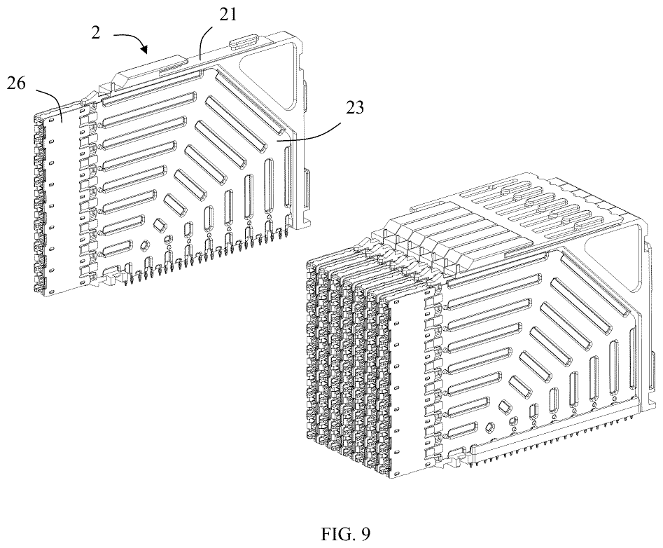

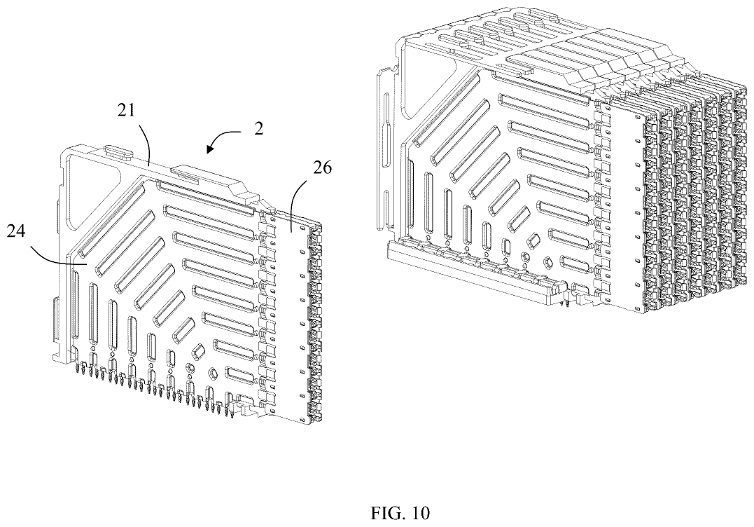

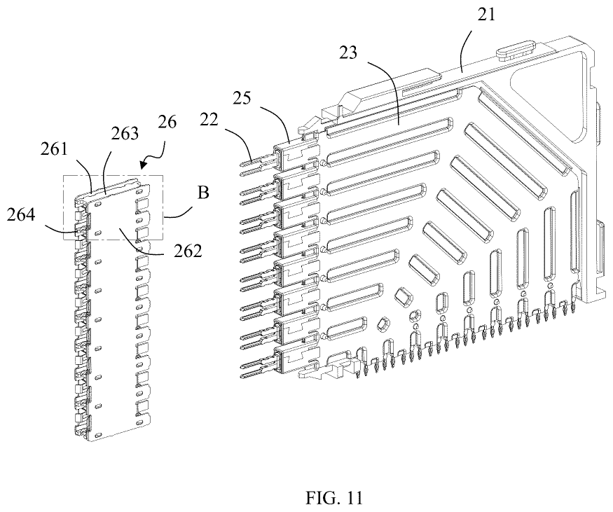

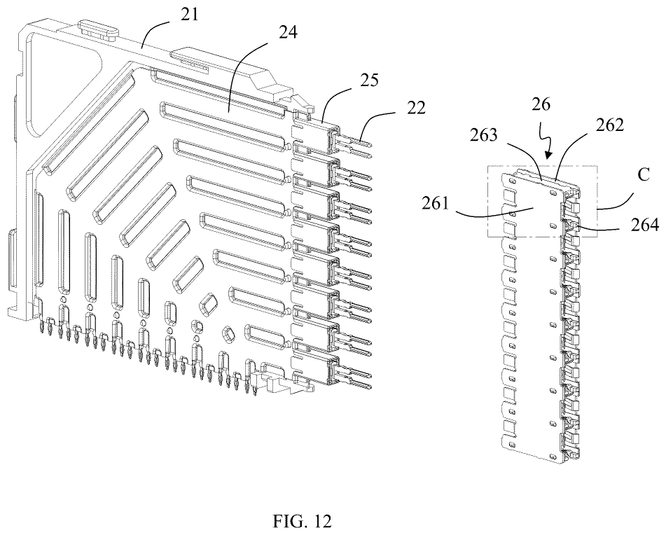

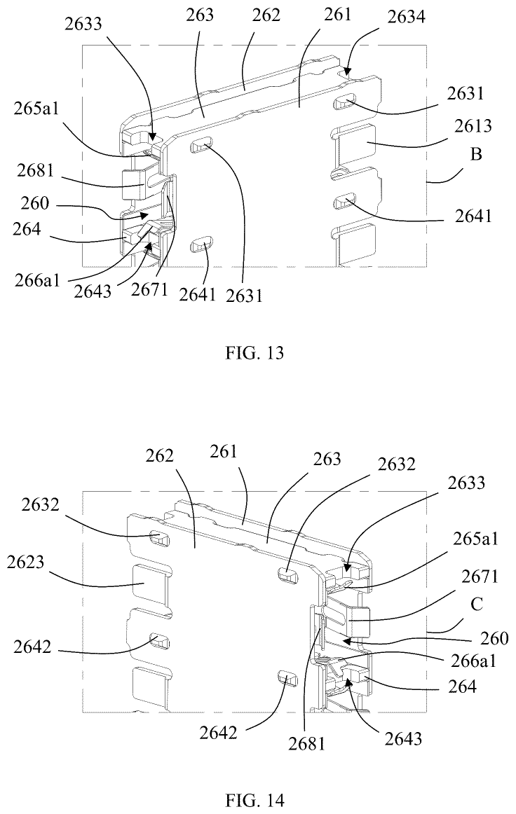

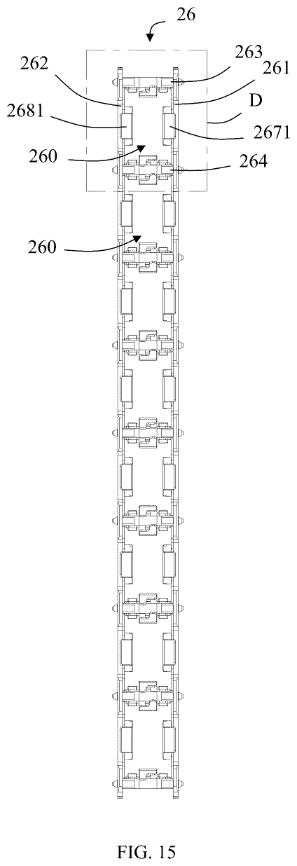

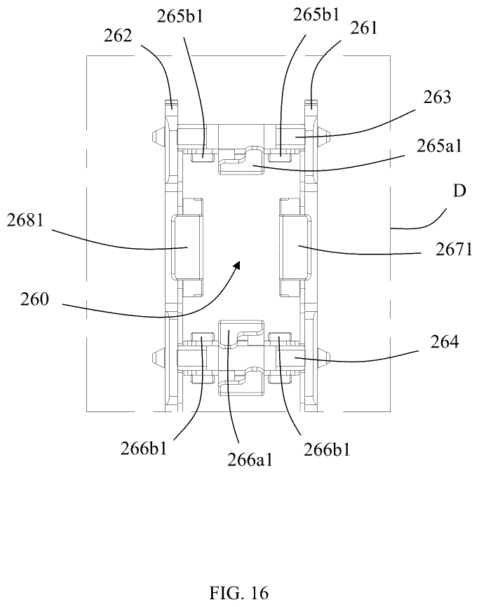

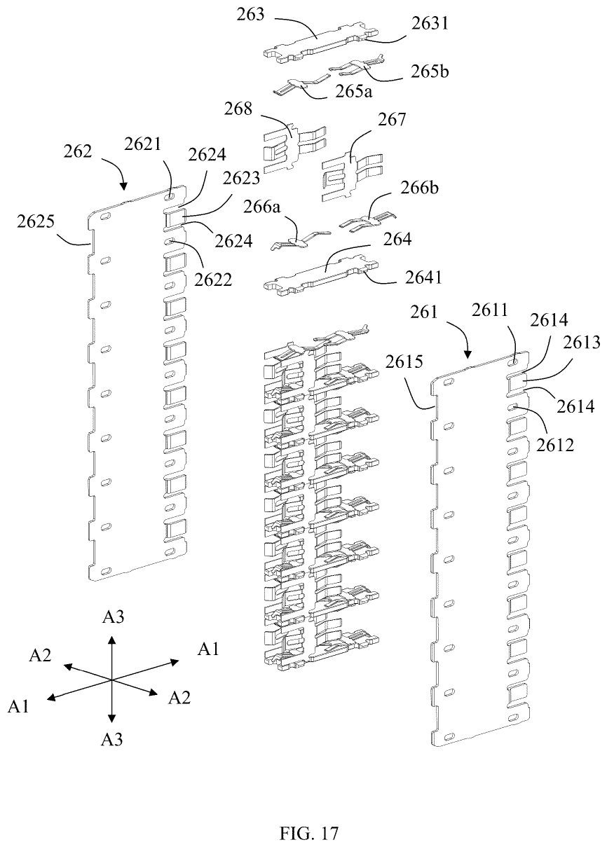

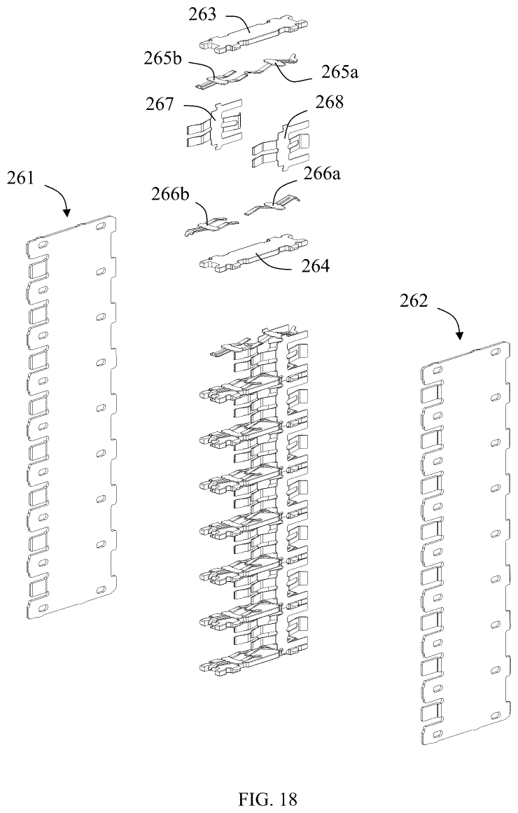

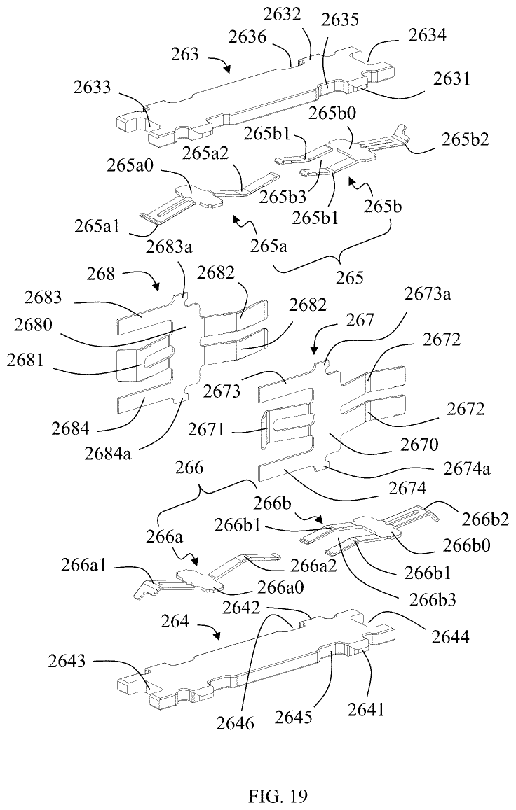

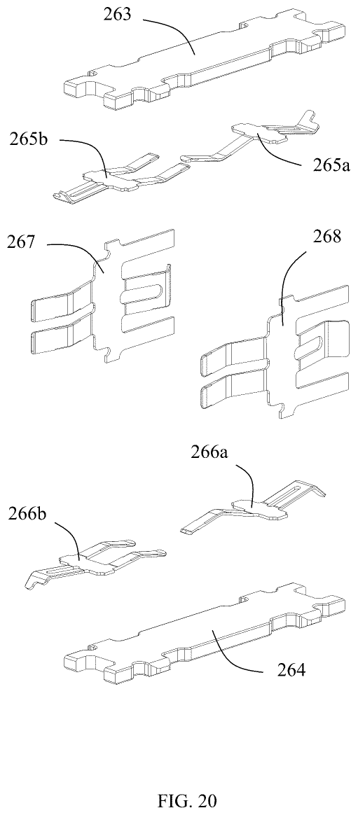

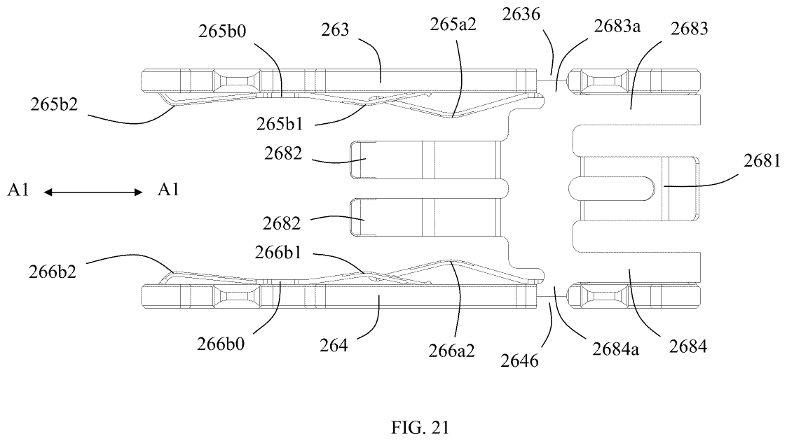

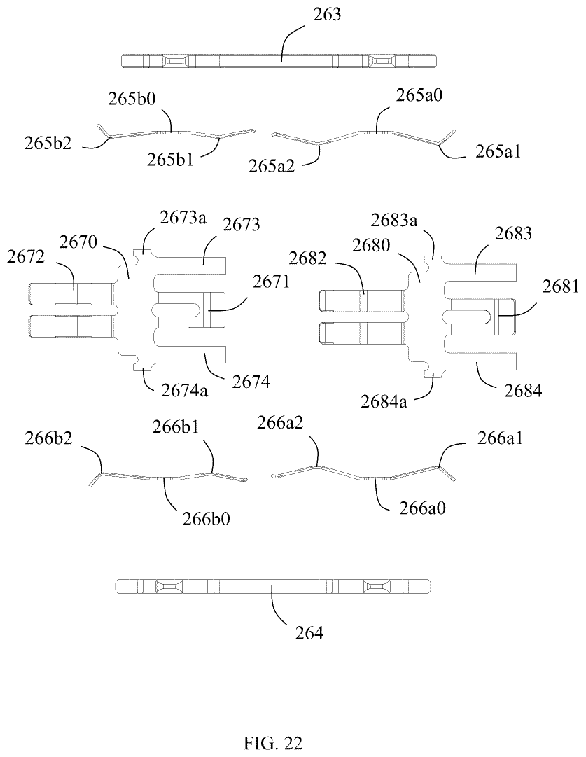

Referring to FIG. 9 to FIG. 28, the first terminal module 2 includes an insulating bracket 21, a plurality of first conductive terminals 22 fixed to the insulating bracket 21, a first metal shielding plate 23 located on one side of the insulating bracket 21, a second metal shielding plate 24 located on another side of the insulating bracket 21, a plurality of first shielding sleeves 25 sleeved on the first metal shielding plate 23 and the second metal shielding plate 24, and an extension shielding shell assembly 26.

The insulating bracket 21 includes a substantially frame-shaped frame portion 210 and a plurality of protrusion blocks 219 which extend from the frame portion 210 and are spaced apart along the third direction A3-A3. The frame portion 210 includes a rear wall 211, a front wall 212 disposed opposite to the rear wall 211, a top wall 213 connecting one end of the rear wall 211 and one end of the front wall 212, a bottom wall 214 connecting another end of the rear wall 211 and another end of the front wall 212, and a plurality of connecting walls 215. The connecting walls 215 are able to enhance the structural strength of the frame portion 210. The rear wall 211 is provided with a first protrusion 2111 and a second protrusion 2112 which protrude backwardly and are spaced apart from each other. The first protrusion 2111 and the second protrusion 2112 are arranged in alignment with each other. The first protrusion 2111 is provided with a first contraction portion 2113. The second protrusion 2112 is provided with a second constriction portion 2114. The top wall 213 is provided with a third protrusion 2133 and a fourth protrusion 2134 which protrude upwardly and are spaced apart along the first direction A1-A1. The third protrusion 2133 and the fourth protrusion 2134 are arranged in alignment with each other along the first direction A1-A1. The third protrusion 2133 is provided with a third constriction portion 2135. The fourth protrusion 2134 is provided with a fourth constriction portion 2136. In the illustrated embodiment of the present disclosure, the insulating bracket 21 is provided with a hollow portion 217. The connecting walls 215 include a first connecting wall 2151 connecting the top wall 213 and the bottom wall 214, and a second connecting wall 2152 connecting the rear wall 211 and the bottom wall 214. The first connecting wall 2151 and the second connecting wall 2152 are exposed in the hollow portion 217. The top wall 213 is provided with a first locking protrusion 2131 for being inserted into the first locking groove 122. The bottom wall 214 is provided with a second locking protrusion 2141 for being inserted into the second locking groove 132.

As shown in FIG. 5, the holding piece 3 includes a generally L-shaped first holding piece 31 and a generally L-shaped second holding piece 32. The first holding piece 31 and the second holding piece 32 may be made of metal sheets. The first holding piece 31 is configured to mate with the first protrusion 2111 and the second protrusion 2112, respectively. The first holding piece 31 defines a plurality of first holding grooves 311 for being in lock with the first contraction portion 2113 and the second contraction portion 2114. Similarly, the second holding piece 32 is configured to mate with the third protrusion 2133 and the fourth protrusion 2134, respectively. The second holding piece 32 defines a plurality of second holding grooves 321 for being in lock with the third contraction portion 2135 and the fourth contraction portion 2136.

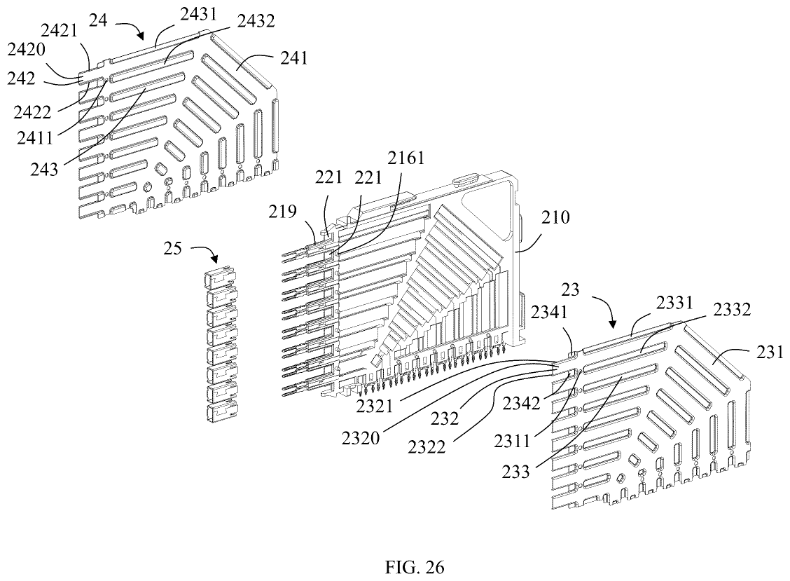

As shown in FIGS. 26 to 28, the insulating bracket 21 is further provided with a plurality of protruding posts 216 for fixing the first metal shielding plate 23 and the second metal shielding plate 24. In the illustrated embodiment of the present disclosure, the protruding posts 216 are disposed on the bottom wall 214 and the front wall 212. Since the first metal shielding plate 23 and the second metal shielding plate 24 are located on two sides of the insulating bracket 21, respectively, the protruding posts 216 include a plurality first protruding posts 2161 and a plurality of second protruding posts 2162. The first protruding posts 2161 and the second protruding posts 2162 are respectively located on opposite sides of the insulating bracket 21 so as to be fixed and positioned with the first metal shielding plate 23 and the second metal shielding plate 24.

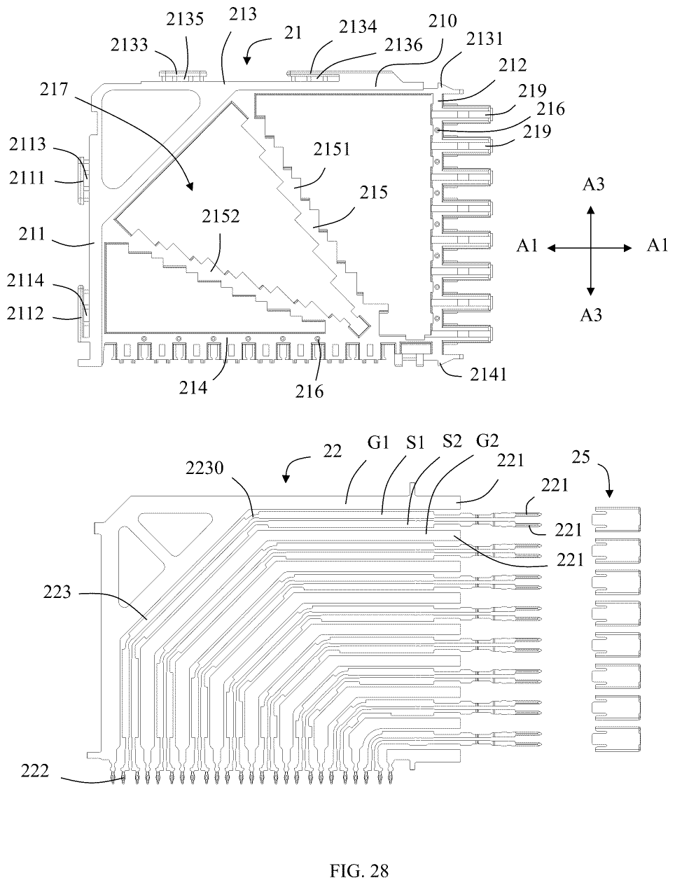

Referring to FIG. 28, from a structural point of view, each first conductive terminal 22 in each group includes a first contact portion 221, a first tail portion 222, and a first connection portion 223 connecting the first contact portion 221 and the first tail portion 222. The first contact portions 221 of some of the first conductive terminals 22 are used to make electrical contact with the second backplane connector 200. The first tail portion 222 is used to be mounted to the circuit board 301 along the third direction A3-A3 (i.e., an installation direction). In the illustrated embodiment of the present disclosure, the first contact portion 221 is substantially perpendicular to the first tail portion 222. The first connection portion 223 is curved.

From a functional point of view, each group of first conductive terminals 22 includes a plurality of first ground terminals G1, a plurality of second ground terminals G2, a plurality of first signal terminals S1 and a plurality of second signal terminals S2. In the illustrated embodiment of the present disclosure, the adjacent first signal terminal S1 and the second signal terminal S2 form a pair of first differential signal terminals. Each pair of first differential signal terminals are located between one first ground terminal G1 and one second ground terminal G2. That is, each group of first conductive terminals 22 is disposed in a G1-S1-S2-G2 arrangement, which is beneficial to improving the quality of signal transmission. The first differential signal terminals are narrow-side coupling or wide-side coupling.

In the illustrated embodiment of the present disclosure, the first connection portions 223 of the first conductive terminals 22 are insert-molded with the insulating bracket 21. Each of the first connection portion 223 of the first signal terminal S1 and the first connection portion 223 of the second signal terminal S2 is provided with a narrowing portion 2230 embedded in the insulating bracket 21 to adjust the impedances of the first signal terminal S1 and the second signal terminal S2 so as to achieve impedance matching. In the illustrated embodiment of the present disclosure, the first contact portions 221 of the first signal terminal S1 and the second signal terminal S2 are both substantially needle-shaped. The first contact portions 221 of the first ground terminal G1 and the second ground terminal G2 are both substantially rectangular plate-shaped. The first contact portions 221 of the first signal terminal S1 and the second signal terminal S2 extend forwardly beyond the first contact portions 221 of the first ground terminal G1 and the second ground terminal G2. The first contact portion 221 of the first signal terminal S1 and the first contact portion 221 of the second signal terminal S2 both protrude forwardly beyond the protrusion block 219 to mate with the second backplane connector 200.

In the illustrated embodiment of the present disclosure, the retaining block 4 defines a plurality of through holes 41. The first tail portion 222 of the first conductive terminal 22 passes through a corresponding through hole 41 along the installation direction, and extends downwardly beyond the retaining block 4.

In the first embodiment illustrated in the present disclosure, the first tail portion 222 of each first conductive terminal 22 is provided with a fisheye hole, so that the first tail portion 222 has a certain elastic deformation ability. The first tail portion 222 of the first signal terminal S1 is inserted into the first signal terminal mounting hole 3011. The first tail portion 222 of the second signal terminal S2 is inserted into the second signal terminal mounting hole 3012. The first tail portion 222 of the first ground terminal G1 is inserted into the first ground terminal mounting hole 3013. The first tail portion 222 of the second ground terminal G2 is inserted into the second ground terminal mounting hole 3014.

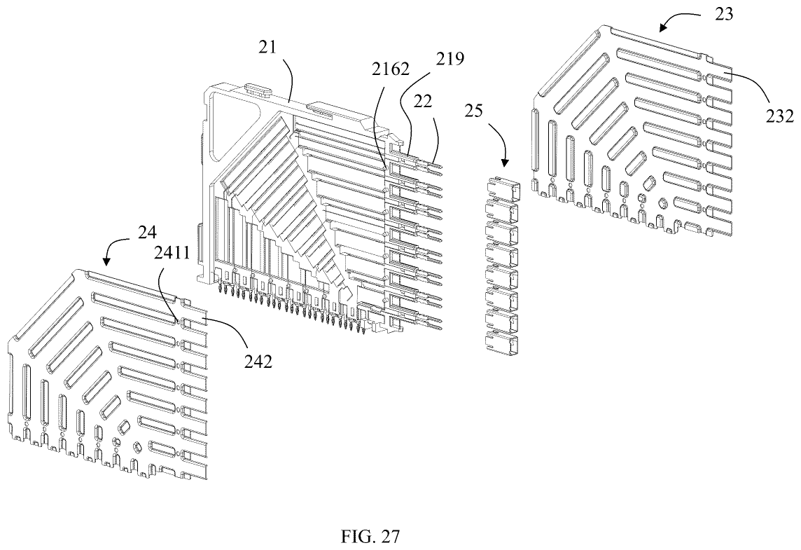

In the illustrated embodiment of the present disclosure, the first metal shielding plate 23 and the second metal shielding plate 24 are symmetrically disposed on two sides of the insulating bracket 21. Referring to FIG. 26 and FIG. 27, the first metal shielding plate 23 includes a first main body portion 231 and a plurality of first extension portions 232 extending from the first main body portion 231. The plurality of first extension portions 232 are spaced apart along the top-bottom direction. The first main body portion 231 is located on one side of the first connection portion 223 of the first conductive terminal 22. The first extension portion 232 is located on one side of the first contact portion 221 and the protrusion block 219. In the illustrated embodiment of the present disclosure, the first main body portion 231 is provided with a plurality of first mounting holes 2311 matching a plurality of first protruding posts 2161. Optionally, the first protruding post 2161 is fixed and positioned in the first mounting hole 2311 by welding or melting, thereby achieving the fixing and positioning of the first metal shielding plate 23 and the insulating bracket 21. The first main body portion 231 is provided with a plurality of ribs 233. The ribs 233 include a first rib 2331 protruding toward the first ground terminal G1 and a second rib 2332 protruding toward the second ground terminal G2. The first rib 2331 is provided along an extending direction of the first connection portion 223 of the first ground terminal G1. The second rib 2332 is provided along an extending direction of the first connection portion 223 of the second ground terminal G2. In the illustrated embodiment of the present disclosure, the first rib 2331 and the second rib 2332 are formed by stamping the first main body portion 231. The first rib 2331 and the second rib 2332 protrude toward the second metal shielding plate 24. The first rib 2331 and the second rib 2332 are disposed discontinuously along the extending directions of the first connection portions 223 of the first ground terminal G1 and the second ground terminal G2 to achieve multi-point contact, thereby improving the contact reliability between the first metal shielding plate 23 and the first ground terminal G1, and the contact reliability between the first metal shielding plate 23 and the second ground terminal G2.

In the illustrated embodiment of the present disclosure, the first extension portion 232 is generally U-shaped and includes a first side surface 2320, a first bent portion 2321 bent from one end (for example, an upper end) of the first side surface 2320 toward the second metal shielding plate 24, and a second bent portion 2322 bent from another end (for example, a lower end) of the first side surface 2320 toward the second metal shielding plate 24.

Similarly, as shown in FIG. 26 and FIG. 27, the second metal shielding plate 24 includes a second main body portion 241 and a plurality of second extension portions 242 extending from the second main body portion 241. The plurality of second extension portions 242 are spaced apart in the top-bottom direction. The second main body portion 241 is located on another side of the first connection portion 223 of the first conductive terminal 22. The second extension portion 242 is located on another side of the protrusion block 219 and the first contact portion 221. In the illustrated embodiment of the present disclosure, the second main body portion 241 defines a plurality of second mounting holes 2411 matching the plurality of second protruding posts 2162. Optionally, the second protruding post 2162 is fixed and positioned in the second mounting hole 2411 by welding or melting, thereby achieving the fixing and positioning of the second metal shielding plate 24 and the insulating bracket 21. The second main body portion 241 is provided with a plurality of ribs 243. The ribs 243 include a third rib 2431 protruding toward the first ground terminal G1 and a fourth rib 2432 protruding toward the second ground terminal G2. The third rib 2431 is provided along the extending direction of the first connection portion 223 of the first ground terminal G1. The fourth rib 2432 is provided along the extending direction of the first connection portion 223 of the second ground terminal G2. In the illustrated embodiment of the present disclosure, the third rib 2431 and the fourth rib 2432 are formed by stamping the second main body portion 241. The third rib 2431 and the fourth rib 2432 protrude toward the first metal shielding plate 23. The third rib 2431 and the fourth rib 2432 are disposed discontinuously along the extending directions of the first connection portions 223 of the first ground terminal G1 and the second ground terminal G2 to achieve multi-point contact, thereby improving the contact reliability between the second metal shielding plate 24 and the first ground terminal G1, and the contact reliability between the second metal shielding plate 24 and the second ground terminal G2. In one embodiment of the present disclosure, welding or soldering is performed on the surfaces of the ribs 233, 243 to fix the ribs 233, 243 to the first ground terminal G1 and the second ground terminal G2. For example, welding is performed on the surfaces of the first rib 2331, the second rib 2332, the third rib 2431 and the fourth rib 2432 to fix the first rib 2331, the second rib 2332, the third rib 2431 and the fourth rib 2432 to the first ground terminal G1 and the second ground terminal G2. The welding method is at least one of spot welding, laser welding and ultrasonic welding.

In the illustrated embodiment of the present disclosure, the second extension portion 242 is generally U-shaped and includes a second side surface 2420, a third bent portion 2421 bent from one end (for example, an upper end) of the second side surface 2420 toward the first metal shielding plate 23, and a fourth bent portion 2422 bent from another end (for example, a lower end) of the second side surface 2420 toward the first metal shielding plate 23.

Along the length of the first connection portion 223 of the first conductive terminal 22, the first rib 2331 and the second rib 2332 of the first metal shielding plate 23, and the third rib 2431 and the fourth rib 2432 of the second metal shielding plate 24 are respectively in contact with two opposite side surfaces of the first connection portion 223 of the first ground terminal G1 and two opposite side surfaces of the first connection portion 223 of the second ground terminal G2. Therefore, a surrounding shielding chamber is formed around an outer periphery of the first connection portions 223 of each pair of first differential signal terminals, thereby improving the quality of signal transmission.

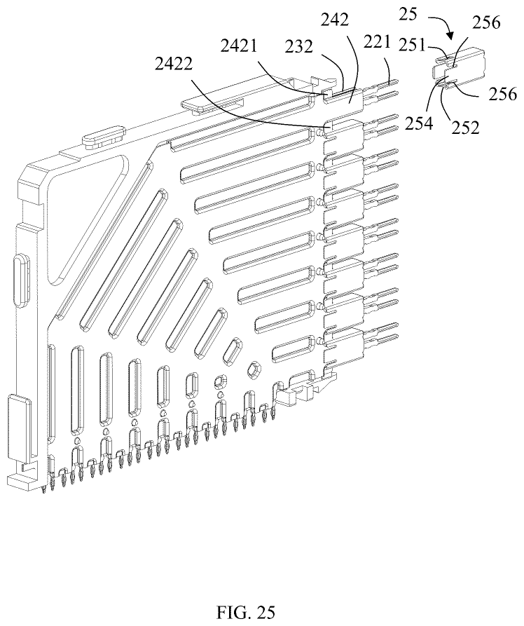

Referring to FIG. 24 and FIG. 25, when the first metal shielding plate 23 and the second metal shielding plate 24 are respectively installed on two sides of the insulating bracket 21, the first extension portion 232 of the first metal shielding plate 23 and the second extension portion 242 of the second metal shielding plate 24 together form a channel portion 240. The protrusion block 219 is at least partially received in the channel portion 240. By providing the protrusion block 219 and having the first conductive terminals 22 partially embedded in the protrusion block 219, on the one hand, the structural strength of the insulating bracket 21 is improved, and on the other hand, it is beneficial to adjusting the impedance of the first conductive terminals 22 and makes it easier to achieve impedance matching. In addition, the first extension portion 232 and the second extension portion 242 that are collectively wrapped around the protrusion block 219 are also beneficial to improving the shielding effect on the first conductive terminals 22.

Of course, it is understandable to those skilled in the art that in other embodiments of the present disclosure, the first terminal module 2 may also include at least one metal shielding plate (for example, the first metal shielding plate 23 or the second metal shielding plate 24). The at least one metal shielding plate is located on at least one side of the insulating bracket 21, and the at least one metal shielding plate is provided with the channel portion 240.

In the illustrated embodiment of the present disclosure, the first contact portion 221 of the first ground terminal G1 and the first contact portion 221 of the second ground terminal G2 are both exposed from the insulating bracket 21. The first metal shielding plate 23 is provided with a first abutting portion 2341 and a second abutting portion 2342 which are located on two sides (for example, upper and lower sides) of the first extension portion 232, respectively. The first abutting portion 2341 is in contact with one side of the first contact portion 221 of the first ground terminal G1. The second abutting portion 2342 is in contact with one side of the first contact portion 221 of the second ground terminal G2. Similarly, the second metal shielding plate 24 is provided with a third abutting portion 2441 and a fourth abutting portion 2442 which are located on two sides (for example, upper and lower sides) of the second extension portion 242, respectively. The third abutting portion 2441 is in contact with another side of the first contact portion 221 of the first ground terminal G1. The fourth abutting portion 2442 is in contact with another side of the first contact portion 221 of the second ground terminal G2. In other words, the first contact portion 221 of the first ground terminal G1 is sandwiched by the first abutting portion 2341 and the third abutting portion 2441. The first contact portion 221 of the second ground terminal G2 is sandwiched by the second abutting portion 2342 and the fourth abutting portion 2442.

The first shielding sleeve 25 is generally in a shape of a hollow rectangular parallelepiped, and is sleeved on the first extension portion 232 of the first metal shielding plate 23 and the second extension portion 242 of the second metal shielding plate 24, which facilitates fixing the first metal shielding plate 23 and the second metal shielding plate 24 to two sides of the insulating bracket 21, respectively. Besides, the first shielding sleeve 25 is made of metal material, that is, the first shielding sleeve 25 is a first metal shielding sleeve. The first shielding sleeve 25 is in contact with the first extension portion 232 and the second extension portion 242. By providing the first shielding sleeve 25, the shielding effect on the first conductive terminals 22 can be further improved.

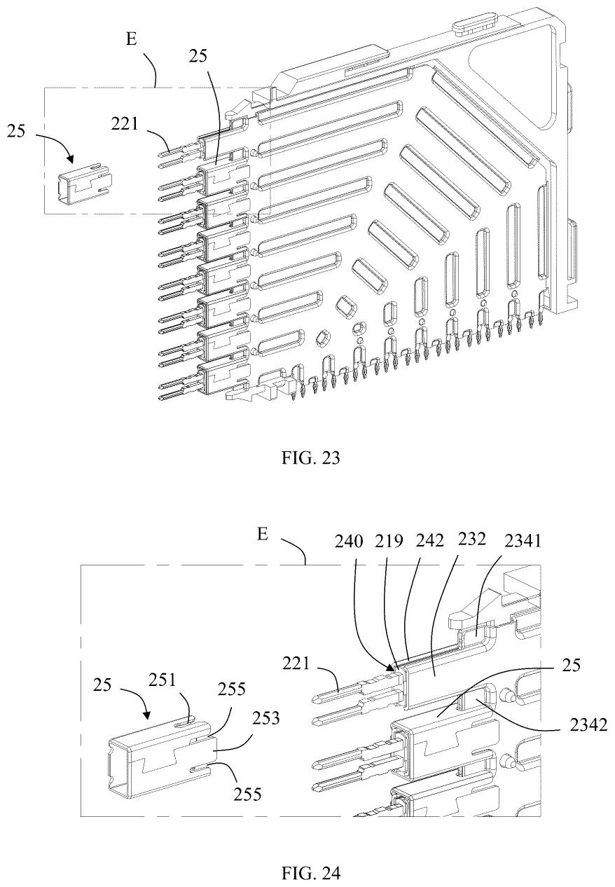

Referring to FIGS. 23 to 25, in the first embodiment of the present disclosure, the first shielding sleeve 25 includes a first clamping slot 251 and a second clamping slot 252. The first abutting portion 2341, the first contact portion 221 of the first ground terminal G1 and the third abutting portion 2441 are tightly inserted in the first clamping slot 251. The second abutting portion 2342, the first contact portion 221 of the second ground terminal G2 and the fourth abutting portion 2442 are tightly inserted in the second clamping slot 252.

Besides, the first shielding sleeve 25 further includes a first contacting tab 253 and a second contacting tab 254 located on two sides, respectively. The first contacting tab 253 and the second contacting tab 254 are in contact with the first metal shielding plate 23 and the second metal shielding plate 24, respectively. In the illustrated embodiment of the present disclosure, in order to increase the degree of fit between the first contacting tab 253 and the first metal shielding plate 23, the first shielding sleeve 25 further defines two first slits 255 between which the first contacting tab 253 is located. Similarly, in order to increase the fit between the second contacting tab 254 and the second metal shielding plate 24, the first shielding sleeve 25 further defines two second slits 256 between which the second contacting tab 254 is located.

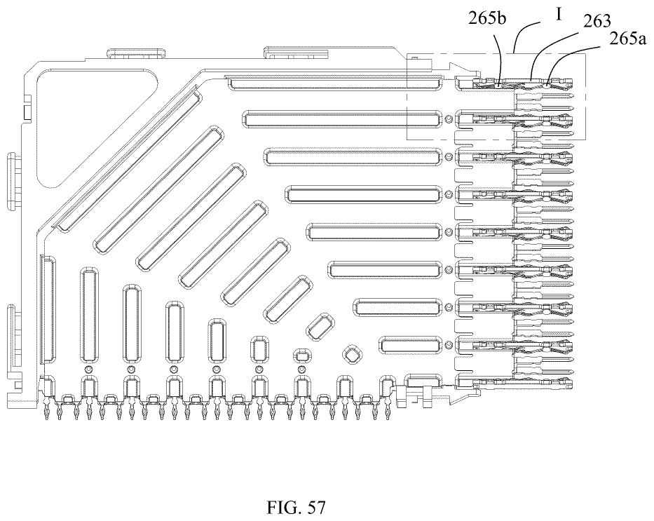

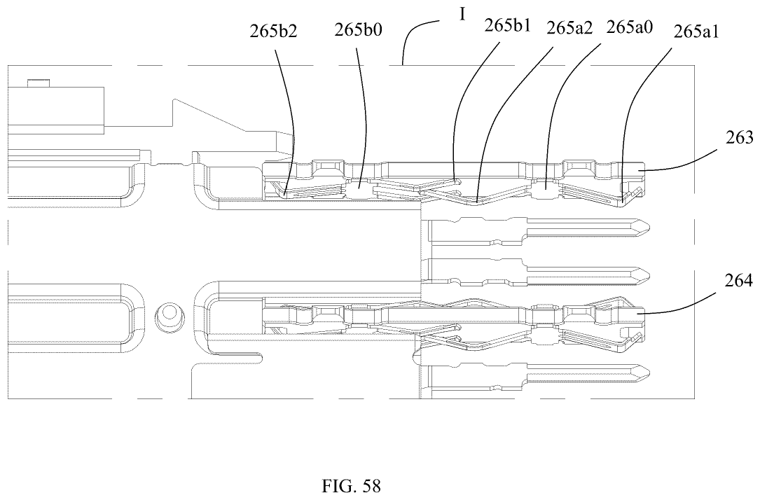

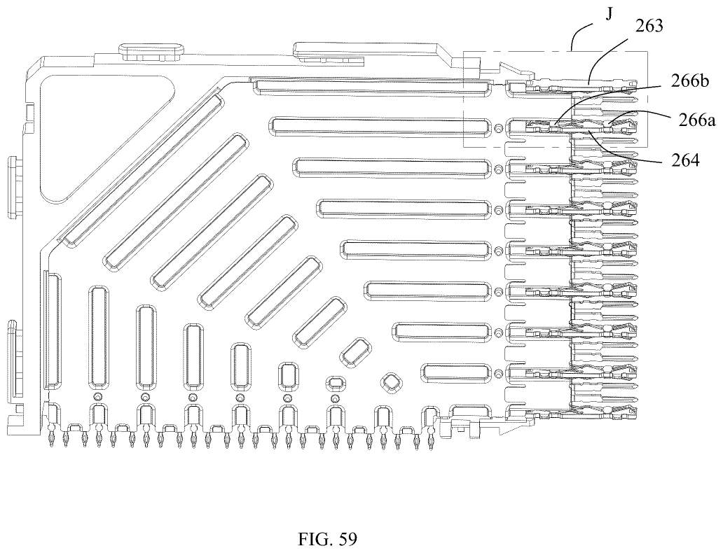

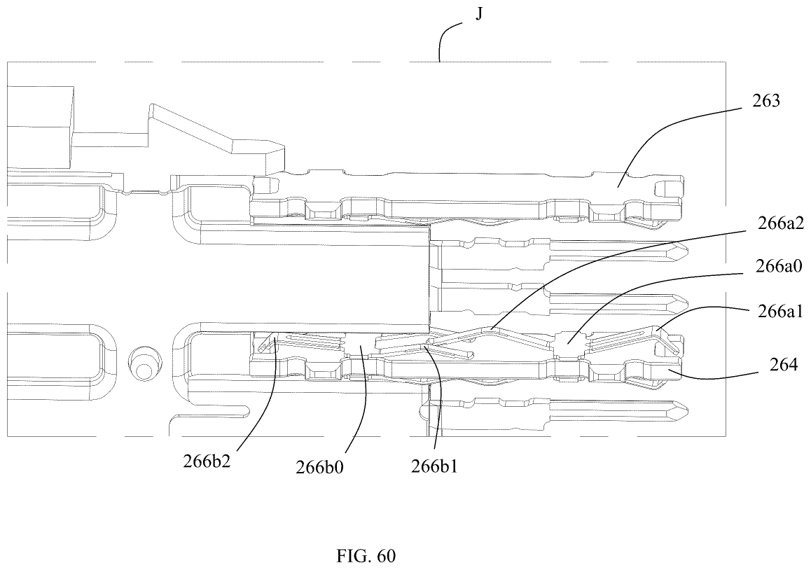

Referring to FIG. 11 to FIG. 22, and FIG. 57 to FIG. 60, in the illustrated embodiment of the present disclosure, the extension shielding shell assembly 26 includes a first extension shielding piece 261, a second extension shielding piece 262, a first connection shielding piece 263, a second connection shielding piece 264, a first elastic piece group 265 fixed to an inner side of the first connection shielding piece 263, a second elastic piece group 266 fixed to an inner side of the second connection shielding piece 264, a first abutting elastic piece 267 fixed to an inner side of the first extension shielding piece 261, and a second abutting elastic piece 268 fixed to an inner side of the second extension shielding piece 262.

Specifically, in the illustrated embodiment of the present disclosure, the extension shielding shell assembly 26 defines a shielding chamber 260 jointly formed by the first extension shielding piece 261, the second extension shielding piece 262, the first connection shielding piece 263 and the second connection shielding piece 264. The first contact portion 221 of the first signal terminal S1 and the first contact portion 221 of the second signal terminal S2 both protrude into the shielding chamber 260. The extension shielding shell assembly 26 can provide a better shielding effect for the first contact portion 221 of the first signal terminal S1 and the first contact portion 221 of the second signal terminal S2. The first elastic piece group 265, the second elastic piece group 266, the first abutting elastic piece 267 and the second abutting elastic piece 268 all at least partially protrude into the shielding chamber 260.

In the illustrated embodiment of the present disclosure, the first extension shielding piece 261 is made of metal material. The first extension shielding piece 261 extends in the top-bottom direction, and includes a plurality of first mounting holes 2611, a plurality of second mounting holes 2612, and a first contact elastic piece 2613 located between the first mounting hole 2611 and the second mounting hole 2612 along the top-bottom direction. In the illustrated embodiment of the present disclosure, the first extension shielding piece 261 further includes a pair of first slits 2614 that communicate with the first contact elastic piece 2613, and are located on the upper and lower sides of the first contact elastic piece 2613, respectively. The first contact elastic piece 2613 is flat-shaped so as to be better attached to the first shielding sleeve 25. In addition, the first extension shielding piece 261 further includes a first groove 2615 that is disposed opposite to the first contact elastic piece 2613.

Similarly, the second extension shielding piece 262 is made of metal material. The second extension shielding piece 262 extends in the top-bottom direction, and includes a plurality of third mounting holes 2621, a plurality of fourth mounting holes 2622, and a second contact elastic piece 2623 located between the third mounting hole 2621 and the fourth mounting hole 2622 along the top-bottom direction. In the illustrated embodiment of the present disclosure, the second extension shielding piece 262 further includes a pair of second slits 2624 that communicate with the second contact elastic piece 2623, and are located on the upper and lower sides of the second contact elastic piece 2623, respectively. The second contact elastic piece 2623 is flat-shaped so as to be better attached to the first shielding sleeve 25. In addition, the second extension shielding piece 262 further includes a second groove 2625 opposite to the second contact elastic piece 2623.

The first connection shielding piece 263 is flat-shaped and made of metal material. The first connection shielding piece 263 extends substantially horizontally along the first direction A1-A1. The first connection shielding piece 263 includes a plurality of first protruding portions 2631 fixed in the first mounting holes 2611 and a plurality of second protruding portions 2632 fixed in the third mounting holes 2621. The first protruding portions 2631 and the second protruding portions 2632 are located on the left and right sides of the first connection shielding piece 263, respectively. The first connection shielding piece 263 is further provided with a first relief groove 2633 and a second relief groove 2634 which are disposed at two ends in the front and rear directions, respectively. The first connection shielding piece 263 is further provided with a first fixing groove 2635 and a second fixing groove 2636 which are located on the left and right sides, respectively.

Similarly, the second connection shielding piece 264 is flat-shaped and made of metal material. The second connection shielding piece 264 extends substantially horizontally along the first direction A1-A1. The second connection shielding piece 264 includes a plurality of third protruding portions 2641 fixed in the second mounting holes 2612 and a plurality of fourth protruding portions 2642 fixed in the fourth mounting holes 2622. The third protruding portions 2641 and the fourth protruding portions 2642 are located on the left and right sides of the second connection shielding piece 264, respectively. The second connection shielding piece 264 is further provided with a third relief groove 2643 and a fourth relief groove 2644 which are disposed at two ends in the front and rear directions, respectively. The second connection shielding piece 264 is further provided with a third fixing groove 2645 and a fourth fixing groove 2646 which are located on the left and right sides, respectively.

In the illustrated embodiment of the present disclosure, the first elastic piece group 265 is made of metal material. The first elastic piece group 265 includes a first elastic piece 265a and a second elastic piece 265b. The first elastic piece 265a includes a first fixing portion 265a0, at least one first elastic arm 265a1 extending from one end of the first fixing portion 265a0, and at least one second elastic arm 265a2 extending from another end of the first fixing portion 265a0. The number and structural form of the first elastic arm 265a1 and the second elastic arm 265a2 can be flexibly adjusted as needed. In the illustrated embodiment of the present disclosure, the first fixing portion 265a0 is fixed to a lower surface of the first connection shielding piece 263. For example, the first fixing portion 265a0 is fixed to the lower surface of the first connection shielding piece 263 by soldering or welding. The first elastic arm 265a1 and the second elastic arm 265a2 are both cantilever arms, that is, they respectively have free ends away from the first fixing portion 265a0.

The second elastic piece 265b includes a second fixing portion 265b0, at least one third elastic arm 265b1 extending from one end of the second fixing portion 265b0, and at least one fourth elastic arm 265b2 extending from another end of the second fixing portion 265b0. In the first embodiment illustrated in the present disclosure, the third elastic arm 265b1 and the fourth elastic arm 265b2 of the second elastic piece 265b are always in contact with the first shielding sleeve 25. When the second elastic piece 265b is abutted against and deformed by the first shielding sleeve 25, the free end of the third elastic arm 265b1 is movable in the second relief groove 2634. The number and structural form of the third elastic arm 265b1 and the fourth elastic arm 265b2 can be flexibly adjusted as needed. In the illustrated embodiment of the present disclosure, the second fixing portion 265b0 is fixed to the lower surface of the first connection shielding piece 263. For example, the second fixing portion 265b0 is fixed to the lower surface of the first connection shielding piece 263 by soldering or welding. The third elastic arm 265b1 and the fourth elastic arm 265b2 are both cantilever arms, that is, they respectively have free ends away from the second fixing portion 265b0. The third elastic arm 265b1 and the fourth elastic arm 265b2 are configured to abut against the second backplane connector 200. The free end of the fourth elastic arm 265b2 is movable in the second relief groove 2634.

In the illustrated embodiment of the present disclosure, the first elastic piece 265a and the second elastic piece 265b are provided separately, and are fixed to the lower surface of the first connection shielding piece 263 by soldering or welding. With this arrangement, the first connection shielding piece 263 itself can be made of metal materials of different materials and/or thicknesses to meet the requirements of structural strength and shielding performance. In addition, the first connection shielding piece 263 and the first elastic piece group 265 are provided separately, which can avoid integrally stamping the first elastic piece group 265 on the first connection shielding piece 263 and leaving openings that may affect the shielding effect.

Of course, it is understandable to those skilled in the art that in other embodiments of the present disclosure, the first elastic piece 265a and the second elastic piece 265b can also be integrally formed.

In the illustrated embodiment of the present disclosure, two third elastic arms 265b1 are provided, and the second elastic piece 265b includes a first receiving groove 265b3 located between the two third elastic arms 265b1. The second elastic arm 265a2 protrudes into the first receiving groove 265b3 along the first direction A1-A1 (for example, the front-back direction) in its free state. In other words, in the free state of the first elastic piece 265a and the second elastic piece 265b, the second elastic arm 265a2 and the third elastic arm 265b1 at least partially overlap in the second direction A2-A2 (for example, the left-right direction).

In the illustrated embodiment of the present disclosure, the second elastic piece group 266 is made of metal material. The second elastic piece group 266 includes a third elastic piece 266a and a fourth elastic piece 266b. The third elastic piece 266a includes a third fixing portion 266a0, at least one fifth elastic arm 266a1 extending from one end of the third fixing portion 266a0, and at least one sixth elastic arm 266a2 extending from another end of the third fixing portion 266a0. The number and structural form of the fifth elastic arm 266a1 and the sixth elastic arm 266a2 can be flexibly adjusted as needed. In the illustrated embodiment of the present disclosure, the third fixing portion 266a0 is fixed to an upper surface of the second connection shielding piece 264. For example, the third fixing portion 266a0 is fixed to the upper surface of the second connection shielding piece 264 by soldering or welding. The fifth elastic arm 266a1 and the sixth elastic arm 266a2 are both cantilever arms, that is, they respectively have free ends away from the third fixing portion 266a0.

The fourth elastic piece 266b includes a fourth fixing portion 266b0, at least one seventh elastic arm 266b1 extending from one end of the fourth fixing portion 266b0, and at least one eighth elastic arm 266b2 extending from another end of the fourth fixing portion 266b0. In the first embodiment illustrated in the present disclosure, the seventh elastic arm 266b1 and the eighth elastic arm 266b2 of the fourth elastic piece 266b are always in contact with the first shielding sleeve 25. When the fourth elastic piece 266b is abutted against and deformed by the first shielding sleeve 25, the free end of the seventh elastic arm 266b1 is movable in the fourth relief groove 2644. The number and structural form of the seventh elastic arm 266b1 and the eighth elastic arm 266b2 can be flexibly adjusted as needed. In the illustrated embodiment of the present disclosure, the fourth fixing portion 266b0 is fixed to the upper surface of the second connection shielding piece 264. For example, the fourth fixing portion 266b0 is fixed to the upper surface of the second connection shielding piece 264 by soldering or welding. The seventh elastic arm 266b1 and the eighth elastic arm 266b2 are both cantilever arms, that is, they respectively have free ends away from the fourth fixing portion 266b0. The seventh elastic arm 266b1 and the eighth elastic arm 266b2 are configured to abut against the second backplane connector 200. The free end of the eighth elastic arm 266b2 is movable in the fourth relief groove 2644.

In the illustrated embodiment of the present disclosure, the third elastic piece 266a and the fourth elastic piece 266b are provided separately, and are fixed to the upper surface of the second connection shielding piece 264 by soldering or welding. With this arrangement, the second connection shielding piece 264 itself can be made of metal materials of different materials and/or thicknesses to meet the requirements of structural strength and shielding performance. In addition, the second connection shielding piece 264 and the second elastic piece group 266 are provided separately, which can avoid integrally stamping and forming the second elastic piece group 266 on the second connection shielding piece 264, which may leave openings that may affect the shielding effect.

Of course, it is understandable to those skilled in the art that in other embodiments of the present disclosure, the third elastic piece 266a and the fourth elastic piece 266b can also be integrally formed.

In the illustrated embodiment of the disclosure, two seventh elastic arms 266b1 are provided, and the fourth elastic piece 266b includes a second receiving groove 266b3 located between the two seventh elastic arms 266b1. The sixth elastic arm 266a2 protrudes into the second receiving groove 266b3 along the first direction A1-A1 in its free state. In other words, in the free state of the third elastic piece 266a and the fourth elastic piece 266b, the sixth elastic arm 266a2 and the seventh elastic arm 266b1 at least partially overlap in the second direction A2-A2.

The first abutting elastic piece 267 includes a first holding portion 2670, at least one first abutting elastic arm 2671 extending from one end of the first holding portion 2670, at least one second abutting elastic arm 2672 extending from another end of the first holding portion 2670, and a first support portion 2673 and the second support portion 2674 which are located on the upper and lower sides of the first abutting elastic arm 2671, respectively. The number and structural form of the first contact elastic arm 2671 and the second contact elastic arm 2672 can be flexibly adjusted as needed. In the illustrated embodiment of the present disclosure, the first holding portion 2670 is fixed to the inner surface of the first extension shielding piece 261. For example, the first holding portion 2670 is fixed to an inner surface of the first extension shielding piece 261 by soldering or welding. The first abutting elastic arm 2671 and the second abutting elastic arm 2672 are both cantilever arms, that is, they respectively have free ends away from the first holding portion 2670. When the first abutting elastic piece 267 is deformed, the free end of the first abutting elastic arm 2671 is movable in the first groove 2615. The first support portion 2673 is provided with a first fixing tab 2673a that is fixed in the first fixing groove 2635. The second support portion 2674 is provided with a second fixing tab 2674a that is fixed in the third fixing groove 2645.

The second abutting elastic piece 268 includes a second holding portion 2680, at least one third abutting elastic arm 2681 extending from one end of the second holding portion 2680, at least one fourth abutting elastic arm 2682 extending from another end of the second holding portion 2680, and a third support portion 2683 and a fourth support portion 2684 which are located on the upper and lower sides of the third abutting elastic arm 2681, respectively. The number and structural form of the third contact elastic arm 2681 and the fourth contact elastic arm 2682 can be flexibly adjusted as needed. In the illustrated embodiment of the present disclosure, the second holding portion 2680 is fixed to an inner surface of the second extension shielding piece 262. For example, the second holding portion 2680 is fixed to the inner surface of the second extension shielding piece 262 by soldering or welding. The third abutting elastic arm 2681 and the fourth abutting elastic arm 2682 are both cantilever arms, that is, they respectively have free ends away from the second holding portion 2680. When the second abutting elastic piece 268 is deformed, the free end of the third abutting elastic arm 2681 is movable in the second groove 2625. The third support portion 2683 is provided with a third fixing tab 2683a that is fixed in the second fixing groove 2636. The fourth support portion 2684 is provided with a fourth fixing tab 2684a that is fixed in the fourth fixing groove 2646.

In the illustrated embodiment of the present disclosure, in order to save costs as much as possible, the first extension shielding piece 261 and the second extension shielding piece 262 may be shared parts; the first connection shielding piece 263 and the second connection shielding piece 264 may be shared parts; the first elastic piece 265a and the third elastic piece 266a may be shared parts; the second elastic piece 265b and the fourth elastic piece 266b may be shared parts; and the first abutting elastic piece 267 and the second abutting elastic piece 268 may be shared parts.

Referring to FIG. 11 to FIG. 22, in the first embodiment of the present disclosure, the first elastic arm 265a1 and the second elastic arm 265a2 of the first elastic piece 265a are spaced apart along the first direction A1-A1 to form two layers of ground contacting points. Therefore, when the second backplane connector 200 is mated with the first backplane connector 100, the ground shielding effect is improved. Similarly, the fifth elastic arm 266a1 and the sixth elastic arm 266a2 of the third elastic piece 266a are spaced apart along the first direction A1-A1 to form two layers of ground contacting points. Therefore, when the second backplane connector 200 is mated with the first backplane connector 100, the ground shielding effect is improved.

In the first embodiment of the present disclosure, the first elastic piece 265a and the second elastic piece 265b are fixed to the first connection shielding piece 263; the third elastic piece 266a and the fourth elastic piece 266b are fixed to the second connection shielding piece 264; the first abutting elastic piece 267 is fixed to the first extension shielding piece 261; and the second abutting elastic piece 268 is fixed to the second extension shielding piece 262. Of course, it is understandable to those skilled in the art that the positions of the first elastic piece 265a and the second elastic piece 265b, the positions of the third elastic piece 266a and the fourth elastic piece 266b, and the positions of the first abutting elastic piece 267 and the second abutting elastic piece 268 can also be exchanged. For example, the first elastic piece 265a and the second elastic piece 265b are fixed to the first extension shielding piece 261; the third elastic piece 266a and the fourth elastic piece 266b are fixed to the second extension shielding piece 262; the first abutting elastic piece 267 is fixed to the first connection shielding piece 263; and the second abutting elastic piece 268 is fixed to the second connection shielding piece 264.

During assembly, first, the first conductive terminals 22 are fixed to the insulating bracket 21. For example, the first conductive terminals 22 are insert-molded with the insulating bracket 21. Then, the first metal shielding plate 23 and the second metal shielding plate 24 are installed on two sides of the insulating bracket 21, respectively. At this time, the first extension portions 232 and the second extension portions 242 together wrap around the protrusion blocks 219. Then, the first shielding sleeves 25 are sleeved on the first extension portions 232 and the second extension portions 242. At the same time, the first abutting portion 2341, the first contact portion 221 of the first ground terminal G1 and the third abutting portion 2441 are jointly inserted into the first clamping slot 251; and the second abutting portion 2342, the first contact portion 221 of the second ground terminal G2 and the fourth abutting portion 2442 are jointly inserted into the second clamping slot 252.

Then, the extension shielding shell assembly 26 is assembled into an integral part, and then assembled with other parts of the first terminal module 2 so as to form the first terminal module 2.

Then, a plurality of first terminal module 2 and the first housing 1 are assembled together.

Then, the first holding piece 31 and the second holding piece 32 are fixed to the first terminal modules 2.

Finally, the retaining block 4 is mounted to the bottom end of the first terminal module 2. The first tail portions 222 of the first conductive terminals 22 pass downwardly through the retaining block 4 along the third direction A3-A3.

In the first embodiment illustrated in the present disclosure, the extension shielding shell assembly 26 increases the ground shielding area and improves the quality of signal transmission by connecting the first shielding sleeves 25, the first metal shielding plate 23, the second metal shielding plate 24, the first ground terminals G1 and the second ground terminals G2 together.

In addition, by providing the extension shielding shell assembly 26 as a separate part, the present disclosure reduces the design complexity of the first metal shielding plate 23, the second metal shielding plate 24, the first ground terminal G1 and the second ground terminal G2.

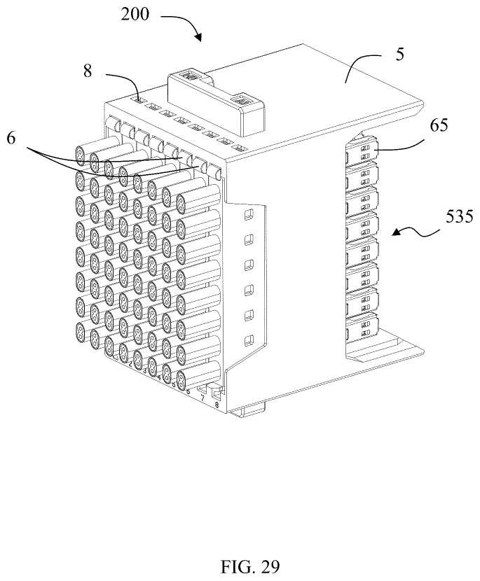

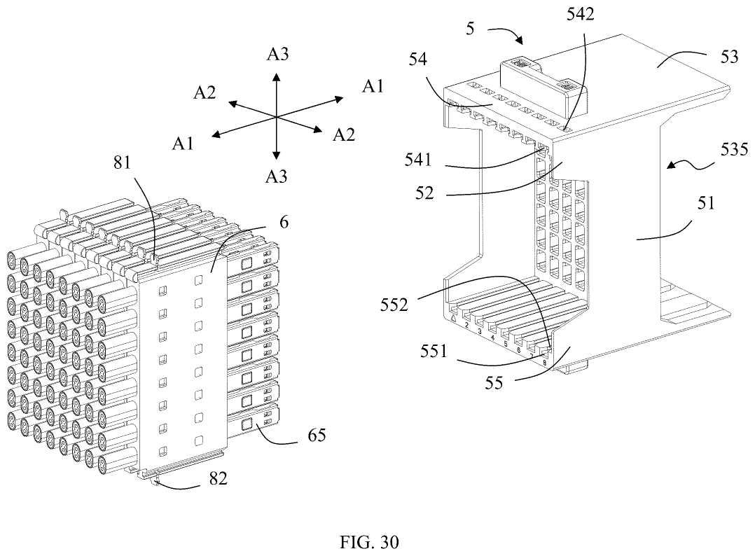

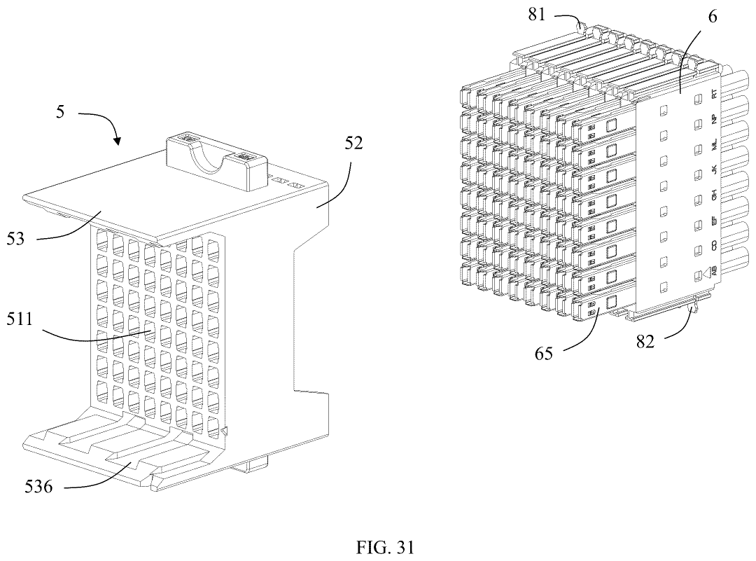

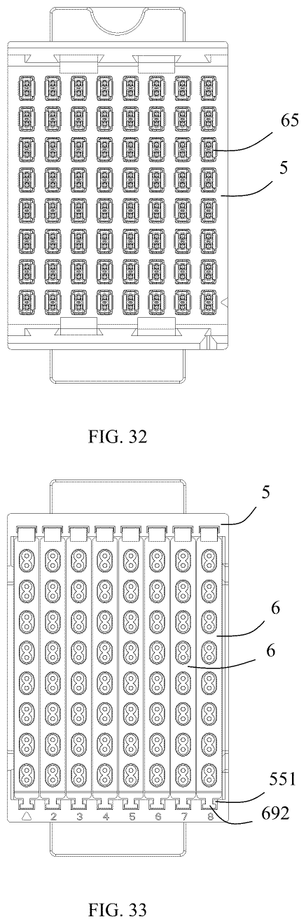

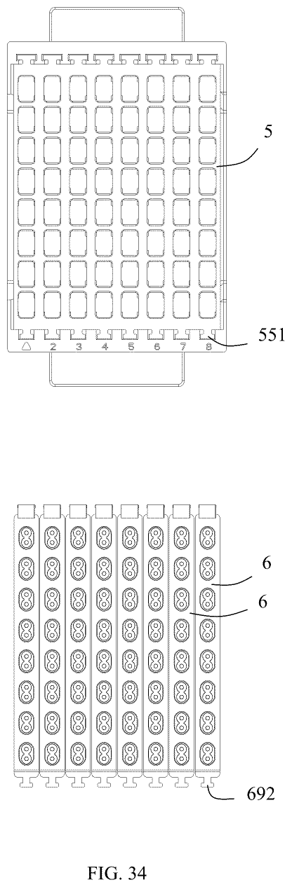

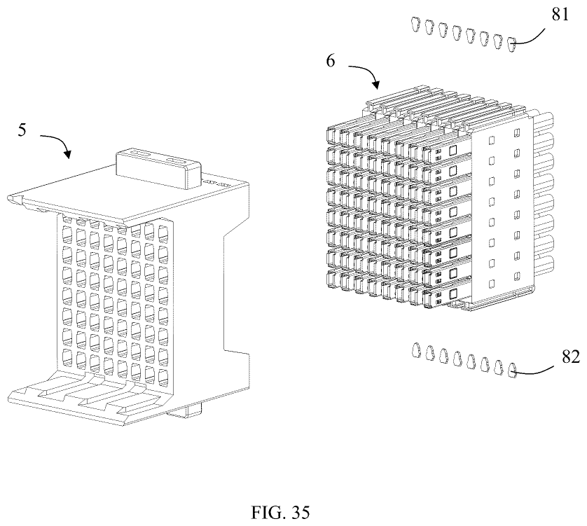

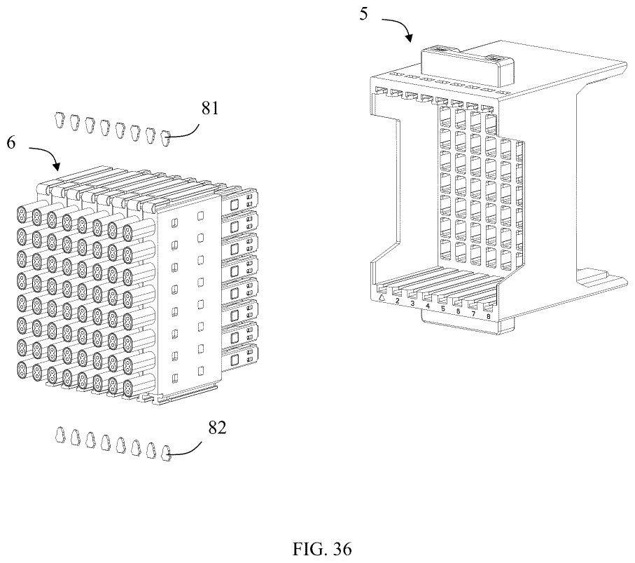

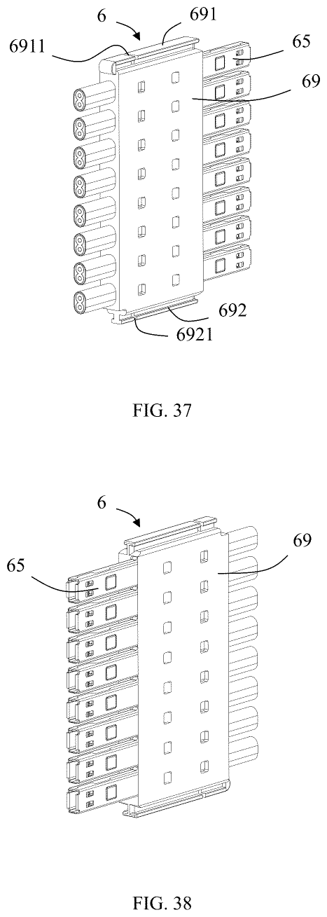

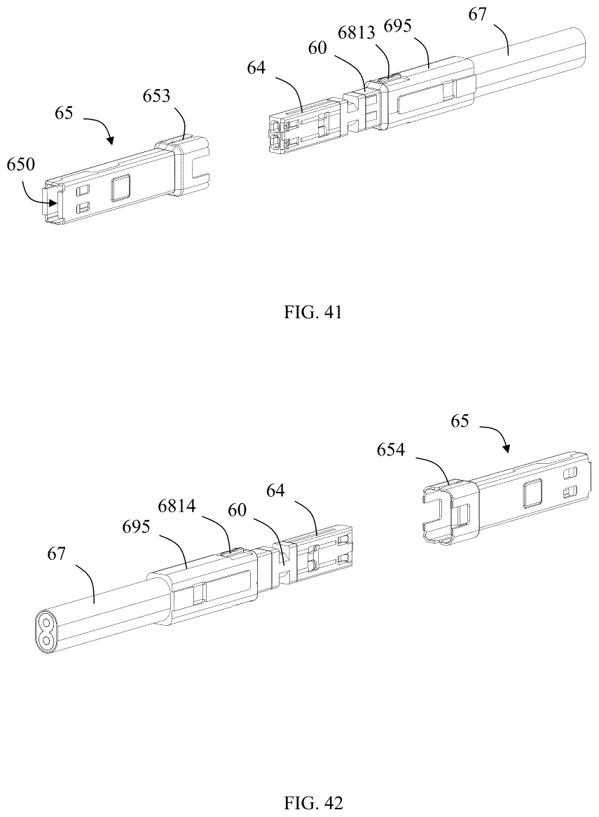

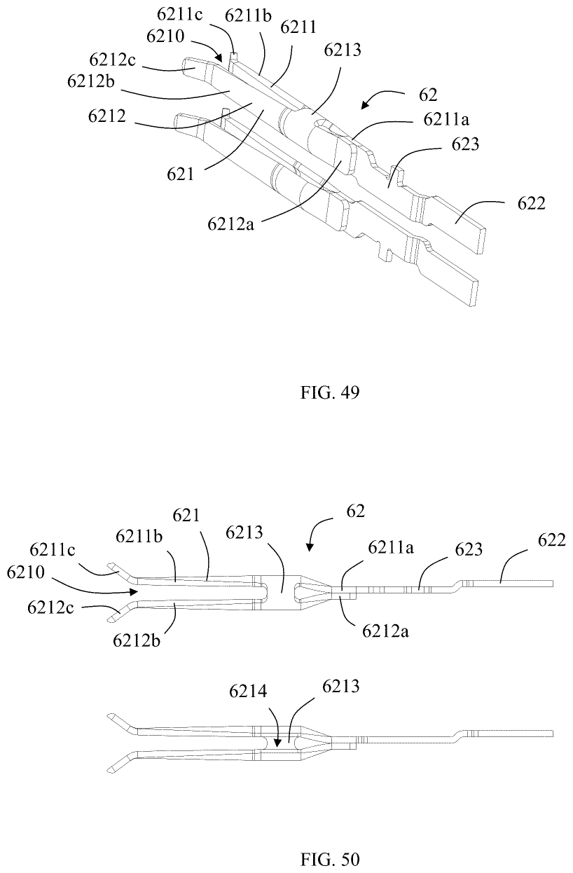

Referring to FIG. 29 to FIG. 50, in the illustrated embodiment of the present disclosure, the second backplane connector 200 is a cable backplane connector, which includes a second housing 5, a plurality of second terminal modules 6 mounted to the second housing 5, and a second positioning pin piece 8 for positioning and retaining the second terminal modules 6 in the second housing 5. The first terminal module 2 and/or the second terminal module 6 are both called terminal modules.

In one embodiment of the present disclosure, the second housing 5 is made of insulating material and includes a second body portion 51, a first extension wall 52 extending from the second body portion 51 to one end, and a second extension wall 53 extending from the second body portion 51 to another end. The second body portion 51 defines a plurality of second terminal module receiving grooves 511 extending through the second body portion 51 along the first direction A1-A1. In the illustrated embodiment of the present disclosure, the second terminal module receiving grooves 511 are arranged in multiple rows along the second direction A2-A2. The first extension wall 52 includes a first extension wall portion 54 and a second extension wall portion 55 disposed oppositely. The second extension wall 53 defines a receiving space 535 and a plurality of positioning grooves 536 located on inner sides the second extension wall 53. The receiving space 535 is used to at least partially receive the first backplane connector 100. The positioning grooves 536 cooperate with the positioning protrusions 14 of the first backplane connector 100 to achieve positioning. The first extension wall portion 54 is provided with a plurality of third insertion slots 541 and a plurality of third locking grooves 542 in communication with the third insertion slots 541. The second extension wall portion 55 defines a plurality of fourth insertion slots 551 and a plurality of fourth locking grooves 552 in communication with the fourth insertion slots 551. The third insertion slots 541 and the fourth insertion slots 551 extend in the front-back direction. The third insertion slot 541 and the fourth insertion slot 551 aligned with each other along the third direction A3-A3 are used to receive a corresponding second terminal module 6. Each of the third locking grooves 542 and the fourth locking grooves 552 extends along the top-bottom direction. The third locking groove 542 extends through the first extension wall 54 along the top-bottom direction to communicate with a corresponding third insertion slot 541. The fourth locking groove 552 extends through the second extension wall 55 along the top-bottom direction to communicate with a corresponding fourth insertion slot 551. In the illustrated embodiment of the present disclosure, each of the fourth insertion slots 551 is T-shaped.

The second terminal module 6 includes a plurality of second cable modules 6a disposed at intervals along the top-bottom direction, a plurality of second shielding sleeves 65 sleeved on the second cable modules 6a, and a second fixing block 69 fixed on the plurality of second cable modules 6a and the second shielding sleeves 65. In one embodiment of the present disclosure, the second fixing block 69 is made of insulating material, and is over-molded on the plurality of second cable modules 6a and the second shielding sleeves 65, so as to be combined with the second cable modules 6a and the second shielding sleeves 65 as a whole. In the illustrated embodiment of the present disclosure, the second fixing block 69 is embedded in slots of the second cable modules 6a during molding so as to increase the bonding force therebetween. Of course, it is understandable to those skilled in the art that the plurality of second cable modules 6a can also be fixed to the second fixing block 69 through assembly or other methods, which will not be described in detail in the present disclosure.

The second fixing block 69 includes a second base portion 690, a third positioning block 691 protruding upwardly from the top of the second base portion 690, and a fourth positioning block 692 protruding downwardly from the bottom of the second base portion 690. In the illustrated embodiment of the present disclosure, the third positioning block 691 is configured to be received in the third insertion slot 541. The third positioning block 691 further defines a third notch 6911 that communicates with the third locking groove 542 in the top-bottom direction. The fourth positioning block 692 is T-shaped and is configured to be received in the fourth insertion slot 551. The fourth positioning block 692 further defines a fourth notch 6921 that communicates with the fourth locking groove 552 in the top-bottom direction.

In one embodiment of the present disclosure, the second positioning pin piece 8 includes a plurality of third pins 81 and a plurality of fourth pins 82. The third pins 81 and the fourth pins 82 are both stamped from metal sheets. The plurality of third pins 81 can be provided separately and fixed in corresponding third locking grooves 542 and the third notches 6911. The plurality of fourth pins 82 can be provided separately and fixed in the corresponding fourth locking grooves 552 and the fourth notches 6921. Of course, in other embodiments, the plurality of third pins 81 can also be connected as a whole through a third material strip (not shown). The plurality of fourth pins 82 may also be connected as a whole through a fourth material strip (not shown). During assembly, the third pins 8 and the fourth pins 82 are integrally installed in the corresponding third locking grooves 542 and the third notches 6911, and the fourth locking grooves 552 and the fourth notches 6921, respectively, to improve installation efficiency. After the assembly is completed, the third material strip and the fourth material strip can be removed or retained according to actual needs. By fixing the second terminal modules 6 with the third pins 81 and the fourth pins 82, it is possible to prevent the second terminal modules 6 from being separated from the second housing 5 in a direction opposite to its assembly direction. In addition, this design saves space because the third pins 81 and the fourth pins 82 can be hidden in the second housing 5, which reduces the size of the second backplane connector 200 to a certain extent, and can also reduce the probability that the third pins 81 and the fourth pins 82 lose their limiting function due to improper external forces.

Each second cable module 6a includes an insulating block 64, a second terminal module 60 mounted to the insulating block 64, a second cable 67 electrically connected to the second terminal module 60, a second shielding clamp 68 clamping the second cable 67, a second over-molding block 695 at least partially fixed on the second terminal module 60, the second shielding clamp 68 and the second cable 67, and a second shielding sleeve 65 at least partially sleeved on the insulating block 64, the second terminal module 60 and the second over-molding block 695. The technical term of “electrically connected” used throughout the present disclosure includes contact connection or non-contact connection, where non-contact connection includes using a transition element to realize the connection between the two components.

In the illustrated embodiment of the present disclosure, the second over-molding block 695 is made of insulating material, and is over-molded on the insulating block 64, the second terminal module 60, the second shielding clamp 68 and the second cable 67 to be combined into a whole.

The second terminal module 60 includes a second holding block 601 and a plurality of second conductive terminals 62 fixed to the second holding block 601. In one embodiment of the present disclosure, the second conductive terminals 62 are insert-molded with the second holding block 601. Of course, in other embodiments, the second conductive terminals 62 can also be fixed to the second holding block 601 through assembly. In the illustrated embodiment of the present disclosure, the second holding block 601 includes a second slot 6011 which extends along a circumferential direction of the second holding block 601.

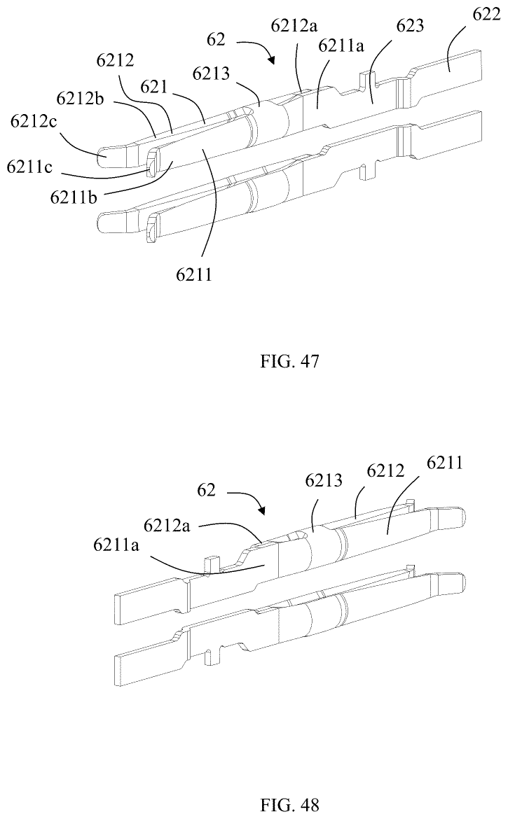

Referring to FIG. 47 to FIG. 50, in the illustrated embodiment of the present disclosure, each group of second conductive terminals 62 includes a second contact portion 621, a second tail portion 622, and a second connection portion 623 connecting the second contact portion 621 and the second tail portion 622. The second connection portion 623 is at least partially fixed in the second holding block 601. The second contact portion 621 extends forwardly beyond the second holding block 601 for contacting the first conductive terminal 22 of the first backplane connector 100. The second tail portion 622 extends backwardly beyond the second holding block 601 for being electrically connected to the second cable 67.

In one embodiment of the present disclosure, two second conductive terminals 62 are provided in each second terminal module 60. Both of the second conductive terminals 62 are mating signal terminals which form a pair of second differential signal terminals to increase the signal transmission rate.

In the illustrated embodiment of the present disclosure, the second contact portion 621 of each second conductive terminal 62 has a two-half structure. The second contact portion 621 of each second conductive terminal 62 includes a first elastic arm 6211, a second elastic arm 6212 disposed opposite to the first elastic arm 6211, and a connecting wall portion 6213 connecting one side of the first elastic arm 6211 and one side of the second elastic arm 6212. The first elastic arm 6211 includes a first tail end portion 6211a connected to the second connection portion 623 and a first contact arm 6211b extending forwardly. The first contact arm 6211b is provided with a first end portion 6211c located at a free end thereof. The second elastic arm 6212 includes a second tail end portion 6212a in contact with the first tail end portion 6211a and a second contact arm 6212b extending forwardly. The second contact arm 6212b is provided with a second end portion 6212c located at a free end thereof. Along the first direction A1-A1, the connecting wall portion 6213 is located between the first contact arm 6211b and the first tail end portion 6211a, and the connecting wall portion 6213 is also located between the second contact arm 6212b and the second tail end portion 6212a.

In the illustrated embodiment of the present disclosure, the first elastic arm 6211 and the second elastic arm 6212 are connected to each other only through the connecting wall portion 6213. In other words, a position of the second conductive terminal 62 opposite to the connecting wall portion 6213 is an opening slot 6214 formed between the first elastic arm 6211 and the second elastic arm 6212, so that the first elastic arm 6211 and the second elastic arm 6212 have better elastic deformation capabilities. In the illustrated embodiment of the present disclosure, the second conductive terminal 62 includes a first clamping space 6210 between the first elastic arm 6211 and the second elastic arm 6212 to receive the first contact portion 221 of the first differential signal terminals of the first backplane connector 100. The first end portion 6211c and the second end portion 6212c together form a bell mouth configuration to guide the first contact portion 221 of the first differential signal terminals to be inserted into the first clamping space 6210.

Compared with the prior art, the second conductive terminal 62 of the present disclosure includes the second tail end portion 6212a which is in contact with the first tail end portion 6211a. It is understandable to those skilled in the art that when a signal is transmitted through the second elastic arm 6212, the signal can be transmitted through the following path: the second elastic arm 6212→the second tail end portion 6212a→the first tail end portion 6211a→the second connection portion 623→the second tail portion 622→the second cable 67. In other words, when a signal is transmitted through the second elastic arm 6212, the signal does not have to pass through the connecting wall 6213 before being transmitted to the second cable 67, thereby improving the efficiency of signal transmission.

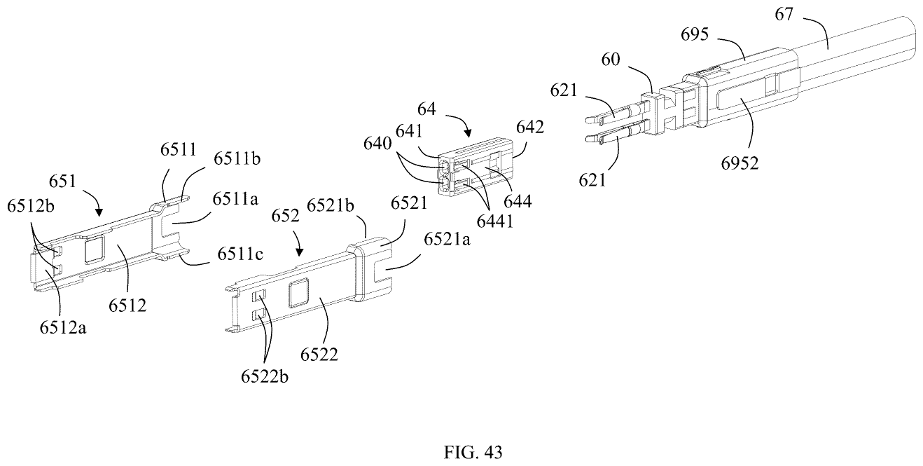

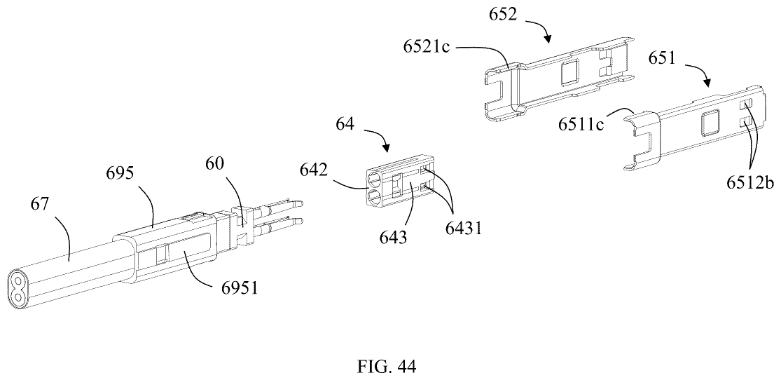

Referring to FIG. 43 and FIG. 44, in the illustrated embodiment of the present disclosure, each insulating block 64 includes a first end surface 641, a second end surface 642 disposed opposite to the first end surface 641, and at least one terminal receiving hole 640 extending through the first end surface 641 and the second end surface 642 along the first direction A1-A1. In the illustrated embodiment of the present disclosure, the insulating block 64 is generally in the shape of a rectangular parallelepiped, and includes a first side wall 643 and a second side wall 644 disposed opposite to the first side wall 643. The first side wall 643 further defines a plurality of first openings 6431 extending through the first side wall 643 and communicating with the terminal receiving hole 640. The second side wall 644 further defines a plurality of second openings 6441 extending through the second side wall 644 and communicating with the terminal receiving hole 640.

The second cable 67 includes a second core 671 for being electrically connected to the second tail portion 622 of the second differential signal terminals, a second insulating layer 672 wrapped around the second core 671, and a second shielding layer 673 located on an outer layer of the second insulating layer 672. In one embodiment of the present disclosure, the second core 671 and the second tail portion 622 of the second differential signal terminals are fixed by soldering or welding. In the illustrated embodiment of the disclosure, the second shielding layer 673 is in contact with the second shielding clamp 68.

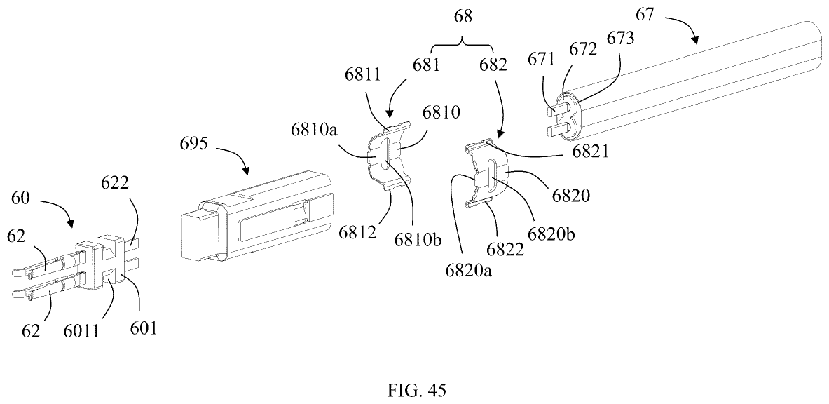

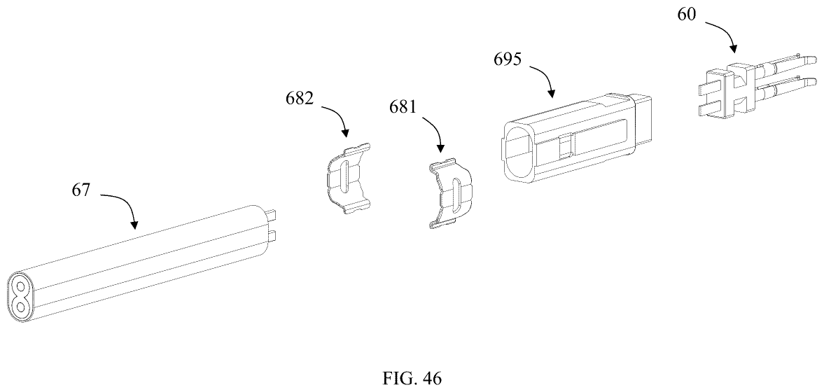

Referring to FIG. 45 and FIG. 46, in the illustrated embodiment of the present disclosure, the second shielding clamp 68 is made of metal material. The second shielding clamp 68 includes a third clamping plate portion 681 and a fourth clamping plate portion 682. The third clamping plate portion 681 and the fourth clamping plate portion 682 are clamped and fixed on the second cable 67. The third clamping plate portion 681 and the fourth clamping plate portion 682 are both in contact with the second shielding layer 673. In the illustrated embodiment of the present disclosure, the second shielding layer 673 is sandwiched by the third clamping plate portion 681 and the fourth clamping plate portion 682.

Of course, it is understandable to those skilled in the art that the second cable 67 can be a cable having a single ground wire, a double ground wire or no ground wire in the prior art. When the second cable 67 adopts the cable having the single ground wire or the double ground wire, the ground wire is configured to be in contact with the second shielding clamp 68 to achieve ground conduction. When the second cable 67 is a cable without the ground wire, the second cable 67 is provided with a shielding layer which is configured to be in contact with the second shielding clamp 68 to achieve ground conduction.

In the illustrated embodiment of the present disclosure, the third clamping plate portion 681 includes a third clamping portion 6810, a fifth tab portion 6811 extending from a top end of the third clamping portion 6810, and a sixth tab portion 6812 extending from a bottom end of the third clamping portion 6810. The third clamping portion 6810 has an arc-shaped third inner surface 6810a and a third opening 6810b extending through the third clamping portion 6810.

The fourth clamping plate portion 682 includes a fourth clamping portion 6820, a seventh tab portion 6821 extending from a top end of the fourth clamping portion 6820, and an eighth tab portion 6822 extending from a bottom end of the fourth clamping portion 6820. The fourth clamping portion 6820 has an arc-shaped fourth inner surface 6820a and a fourth opening 6820b extending through the fourth clamping portion 6820.

The third clamping portion 6810 and the fourth clamping portion 6820 jointly clamp the second cable 67. The third opening 6810b and the fourth opening 6820b can be filled with solder, so that the second shielding clamp 68 and the second shielding layer 673 can be easily soldered.

In the illustrated embodiment of the present disclosure, the fifth tab portion 6811 and the seventh tab portion 6821 abut against each other to form a third insertion tab 6813. The sixth tab portion 6812 and the eighth tab portion 6822 abut against each other to form a fourth insertion tab 6814. The third insertion tab 6813 and the fourth insertion tab 6814 are both in contact with the second shielding sleeve 65.

In an embodiment of the present disclosure, the second over-molding block 695 is over-molded on the second terminal module 60, the second shielding clamp 68 and the second cable 67, so as to be integrated with the second terminal module 60, the second shielding clamp 68 and the second cable 67. Specifically, the second over-molding block 695 is embedded in the second slot 6011 of the second holding block 601 to improve the combination reliability thereof. The third insertion tab 6813 and the fourth insertion tab 6814 extend upwardly and downwardly to protrude beyond the second over-molding block 695, respectively.

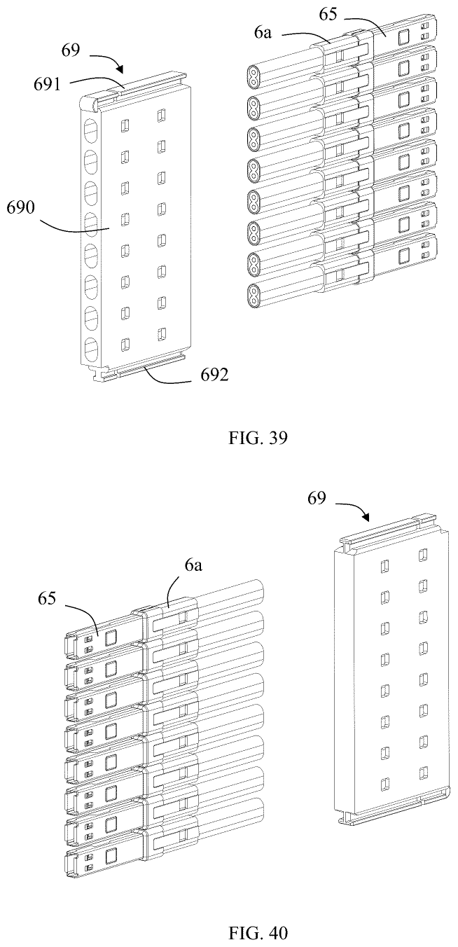

Referring to FIG. 39 to FIG. 44, the second shielding sleeve 65 is at least partially sleeved on the insulating block 64, the second terminal module 60 and the second over-molding block 695 in order to better shield the second conductive terminals 62. The second shielding sleeve 65 includes a shielding cavity 650 in which the insulating block 64 and the second terminal module 60 are at least partially located.

In the illustrated embodiment of the present disclosure, the second shielding sleeve 65 includes a first shielding piece 651 and a second shielding piece 652. The first shielding piece 651 and the second shielding piece 652 jointly form a surrounding shielding configuration. Preferably, in order to save costs, the first shielding piece 651 and the second shielding piece 652 are shared parts, that is, the first shielding piece 651 and the second shielding piece 652 are the same part with different installation angles.

The first shielding piece 651 includes a first rear end portion 6511 and a first shielding portion 6512 extending forwardly from the first rear end portion 6511. A side of the first rear end 6511 defines a first positioning notch 6511a extending backwardly through the first rear end 6511. The first positioning notch 6511a is configured to receive the first positioning protrusion 6951 of the second over-molding block 695. A top of the first rear end portion 6511 defines a first recessed slot 6511b. A bottom of the first rear end portion 6511 defines a second recessed slot 6511c. A front end of the first shielding portion 6512 is further provided with a first folding piece 6512a that is folded backwardly. The first folding piece 6512a is located inside the first shielding portion 6512. In addition, the first shielding portion 6512 further defines a plurality of first opening portions 6512b extending through the first shielding portion 6512. The first opening portion 6512b corresponds to the first opening 6431 of the insulating block 64. The first end portion 6211c of the first contact arm 6211b is elastically deformable in the first opening 6431 and the first opening portion 6512b.

Similarly, the second shielding piece 652 includes a second rear end portion 6521 and a second shielding portion 6522 extending forwardly from the second rear end portion 6521. A side of the second rear end 6521 defines a second positioning notch 6521a extending backwardly through the second rear end 6521. The second positioning notch 6521a is configured to receive the second positioning protrusion 6952 of the second over-molding block 695. A top of the second rear end portion 6521 defines a third recessed slot 6521b. A bottom of the second rear end portion 6521 defines a fourth recessed slot 6521c. A front end of the second shielding portion 6522 further includes a second folding piece 6522a that is folded backwardly. The second folding piece 6522a is located inside the second shielding portion 6522. In addition, the second shielding portion 6522 further defines a plurality of second opening portions 6522b extending through the second shielding portion 6522. The second opening portion 6522b corresponds to the second opening 6441 of the insulating block 64. The second end portion 6212c of the second contact arm 6212b is elastically deformable in the second opening 6441 and the second opening portion 6522b.

When the first shielding piece 651 and the second shielding piece 652 mate with each other, the first shielding portion 6512 and the second shielding portion 6522 jointly form the surrounding shielding cavity 650. The first recessed slot 6511b and the third recessed slot 6521b together form a third clamping slot 653 for receiving the third insertion tab 6813; and the second recessed slot 6511c and the fourth recessed slot 6521c together form a fourth clamping slot 654 for receiving the fourth insertion tab 6814. The first folding piece 6512a and the second folding piece 6522a are both exposed in the shielding cavity 650 to adjust impedance and reduce the amplitude of impedance changes, which is beneficial to improving the quality of signal transmission.

During assembly, the second terminal module 60 and the second cable 67 are fixed by soldering or welding. Then, the second over-molding block 695 is formed on the second terminal module 60 and the second cable 67. Then, the second terminal module 60 is at least partially inserted into the insulating block 64, so that the first contact arm 6211b and the second contact arm 6212b of the second conductive terminal 62 are inserted into the corresponding terminal receiving hole 640. Then, the first shielding piece 651 and the second shielding piece 652 are installed on the insulating block 64 and the second over-molding block 695. The third insertion tab 6813 is fixed in the third clamping slot 653; and the fourth insertion tab 6814 is fixed in the fourth clamping slot 654, so that the second shielding clamp 68 is in contact with the second shielding sleeve 65 to improve the shielding effect. Then, the second fixing block 69 is fixed on the second cable module 6a and the second shielding sleeve 65. Finally, the second terminal module 6 and the second housing 5 are assembled and fixed through the second positioning pin piece 8.

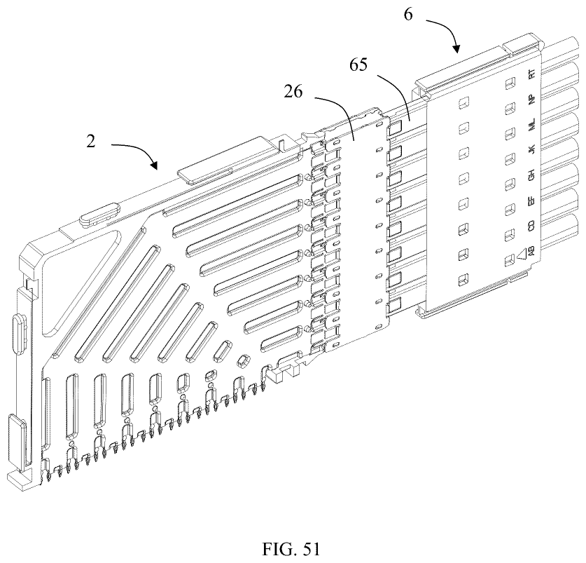

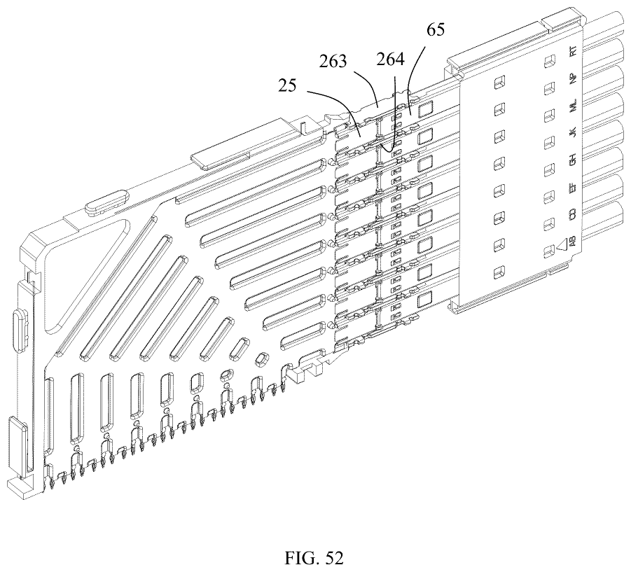

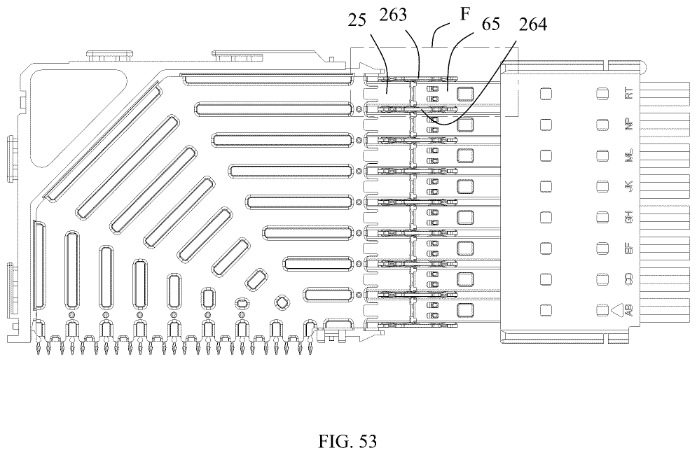

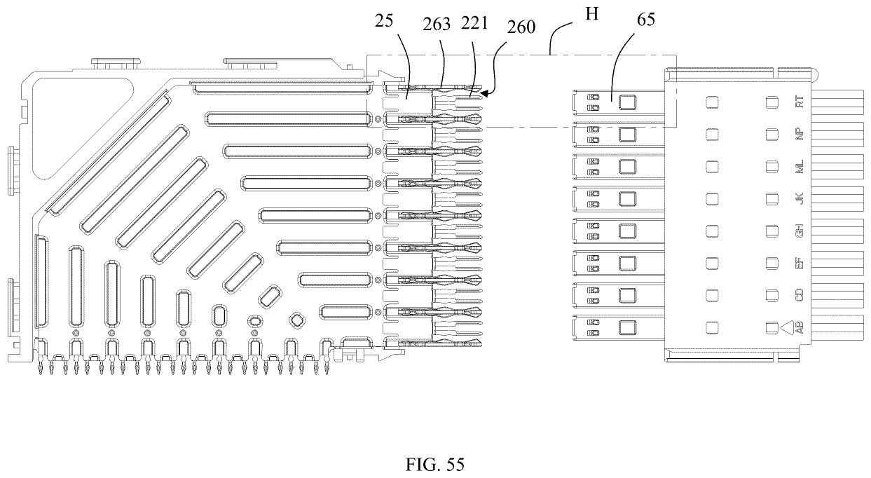

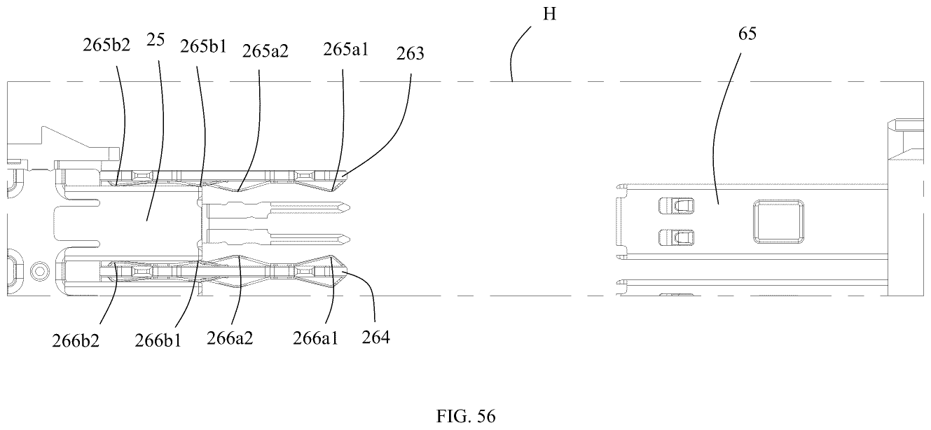

Referring to FIG. 1 and FIG. 51 to FIG. 60, when the first backplane connector 100 is in mating with the second backplane connector 200, the first backplane connector 100 is at least partially inserted into the in the receiving space 535 of the second backplane connector 200, and the second shielding sleeve 65 is inserted into the shielding chamber 260. During the insertion of the second shielding sleeve 65 into the shielding chamber 260, the second shielding sleeve 65 firstly contacts the first elastic arm 265a1 of the first elastic piece 265a, the fifth elastic arm 266a1 of the third elastic piece 266a, the first abutting elastic arm 2671 of the first abutting elastic piece 267, and the third abutting elastic arm 2681 of the second abutting elastic piece 268 along the first direction A1-A1. As the second shielding sleeve 65 is further inserted, the second shielding sleeve 65 then contacts the second elastic arm 265a2 of the first elastic piece 265a, the sixth elastic arm 266a2 of the third elastic piece 266a, the second abutting elastic arm 2672 of the first abutting elastic piece 267 and the fourth abutting elastic arm 2682 of the second abutting elastic piece 268. With this arrangement, the extension shielding shell assembly 26 provides two layers of ground contacts along the first direction A1-A1. The first layer of ground contact points includes the first elastic arm 265a1 of the first elastic piece 265a, the fifth elastic arm 266a1 of the third elastic piece 266a, the first abutting elastic arm 2671 of the first abutting elastic piece 267, and the third abutting elastic arm 2681 of the second abutting elastic piece 268. The second layer of ground contact points includes the second elastic arm 265a2 of the first elastic piece 265a, the sixth elastic arm 266a2 of the third elastic piece 266a, the second abutting elastic arm 2672 of the first abutting elastic piece 267 and the fourth abutting elastic arm 2682 of the second abutting elastic piece 268. By providing the above structures, when the second backplane connector 200 is mated with the first backplane connector 100, it is beneficial to improving the ground shielding effect and improve the quality of signal transmission.

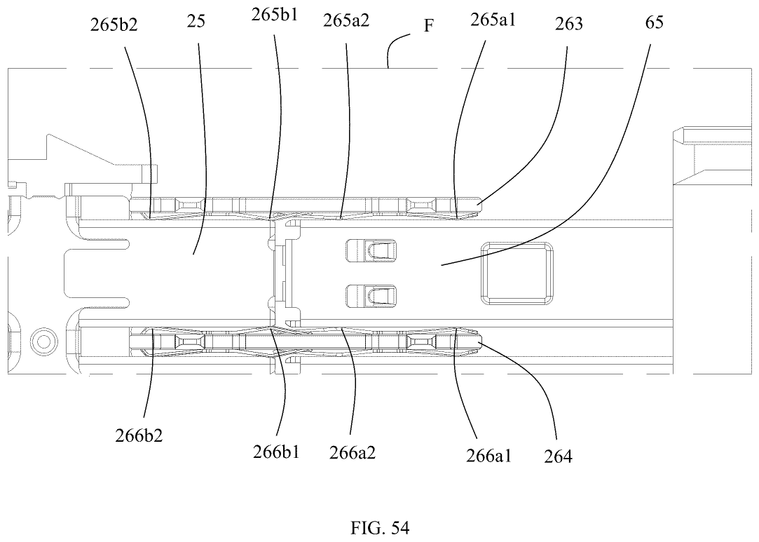

Referring to FIG. 54, in the illustrated embodiment of the present disclosure, the height of the first shielding sleeve 25 along the top-bottom direction is substantially the same as the height of the second shielding sleeve 65 along the top-bottom direction. When the second backplane connector 200 and the first backplane connector 100 are mated in place, the first contact portion 221 of the first signal terminal S1 and the first contact portion 221 of the second signal terminal S2 are respectively inserted into the first clamping spaces 6210 of the second conductive terminals 62 to achieve electrical conduction. When the second backplane connector 200 and the first backplane connector 100 are mated in place, the second shielding sleeve 65 does not be in directly contact with the first shielding sleeve 25 along the first direction A1-A1.

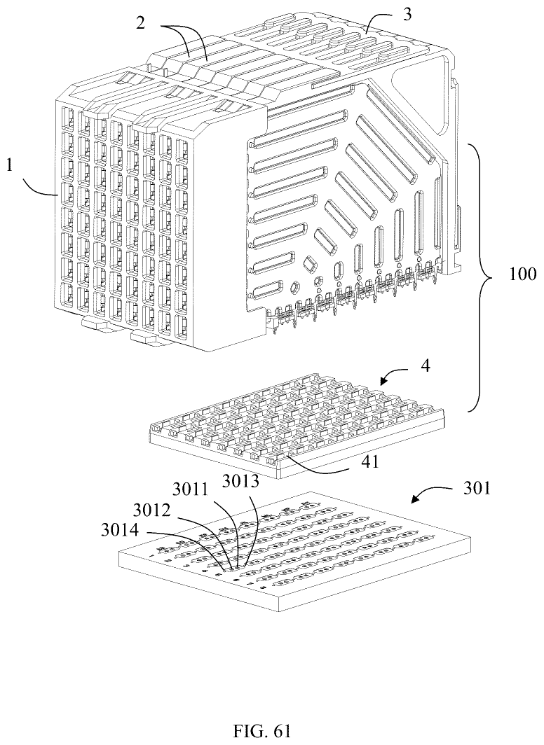

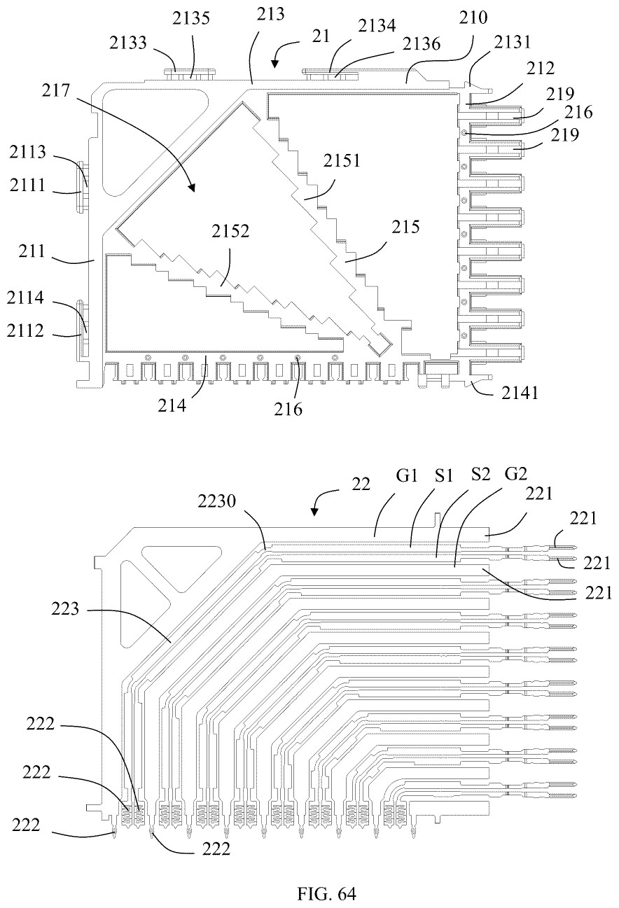

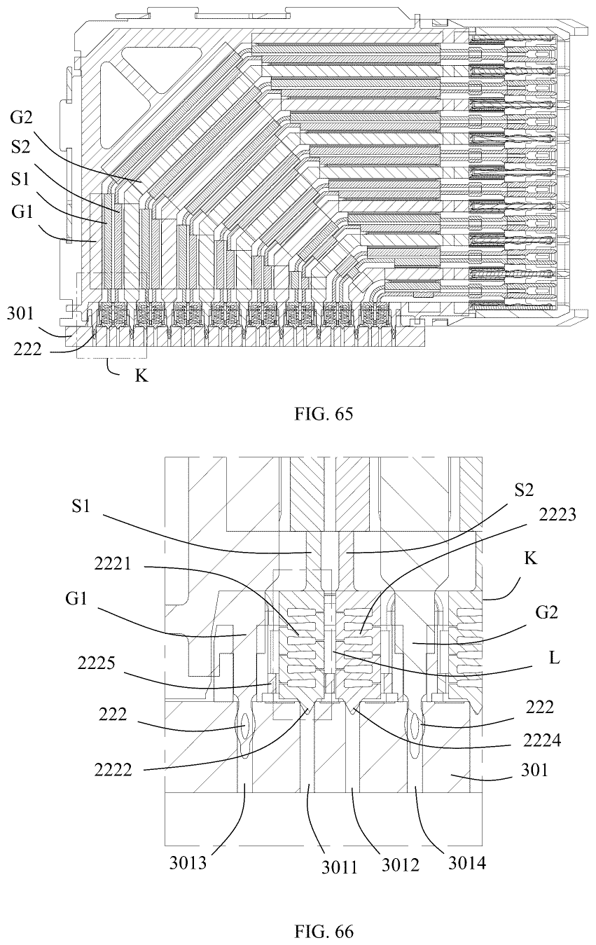

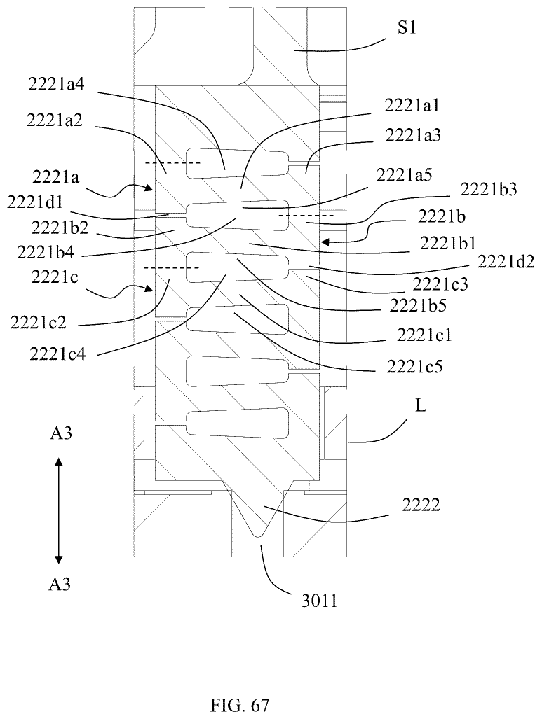

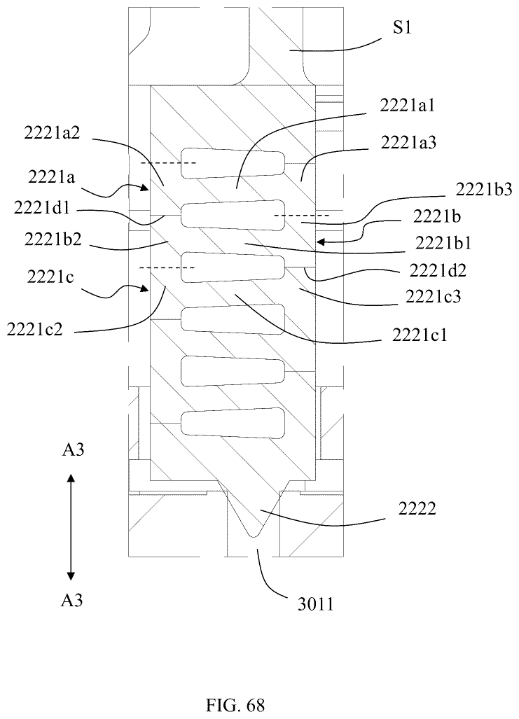

As shown in FIGS. 61 to 68, a second embodiment of the present disclosure discloses a first backplane connector 100 for being mounted to a circuit board 301.

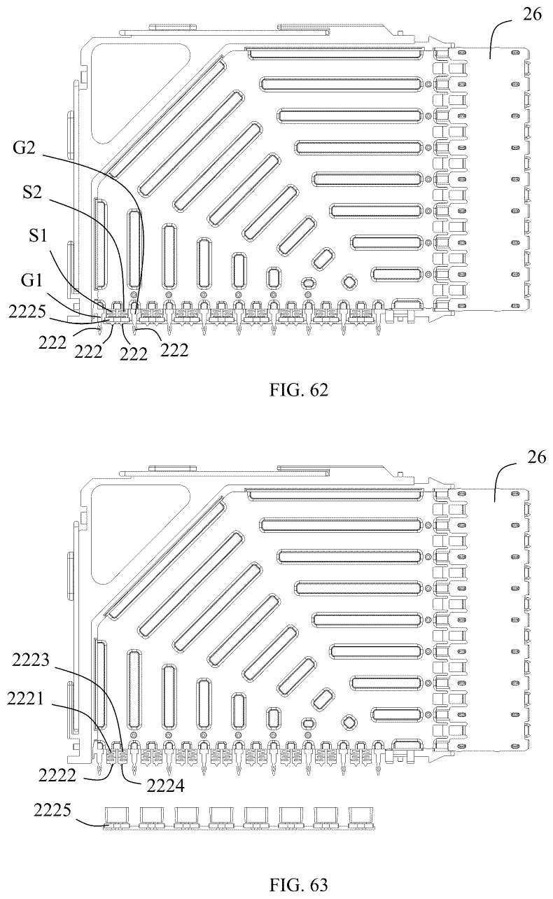

As shown in FIG. 62, in the second embodiment of the present disclosure, the circuit board 301 defines a plurality of first signal terminal mounting holes 3011, a plurality of second signal terminal mounting holes 3012, a plurality of first ground terminal mounting holes 3013 and a plurality of second ground terminal mounting holes 3014. In the illustrated embodiment of the present disclosure, the plurality of first signal terminal mounting holes 3011, the plurality of second signal terminal mounting holes 3012, the plurality of first ground terminal mounting holes 3013 and the plurality of second ground terminal mounting holes 3014 are arranged in matrix. The first signal terminal mounting hole 3011 and the second signal terminal mounting hole 3012, which are disposed adjacent to each other along the first direction A1-A1, form a group of signal differential pair terminal mounting holes. Each pair of signal differential pair terminal mounting holes are associated with one first ground terminal mounting hole 3013 and one second ground terminal mounting hole 3014 which are disposed at two ends of the pair of signal differential pair terminal mounting holes in order to improve the quality of signal transmission. In the first embodiment of the present disclosure, the first signal terminal mounting holes 3011, the second signal terminal mounting holes 3012, the first ground terminal mounting holes 3013 and the second ground terminal mounting holes 3014 are conductive holes. That is, a conductive material (for example, metal) is formed on an inner wall of each conductive hole. When a tail portion of a conductive terminal contacts the conductive material, electrical conduction can be established with the circuit board 301. As for the shape, size and whether the conductive holes extend through the circuit board 301, etc., they can be flexibly designed according to needs, which will not be described in detail in the present disclosure.

The first backplane connector 100 in the second embodiment of the present disclosure includes a first housing 1, a plurality of first terminal modules 2 mounted to the first housing 1, a plurality of holding pieces 3 for holding the plurality of first terminal modules 2 together, and a retaining block 4 held at the bottom ends of the plurality of first terminal modules 2.

The first backplane connector 100 in the second embodiment of the present disclosure is substantially the same as the first backplane connector 100 in the first embodiment of the present disclosure. For the same or corresponding parts between the two, reference can be made to the description of the first backplane connector 100 in the first embodiment, and only the main differences between the two will be described below in detail.

In the second embodiment of the first backplane connector 100 of the present disclosure, each group of first conductive terminals 22 includes a first contact portion 221, a first tail portion 222, and a first connection portion 223 connecting the first contact portion 221 and the first tail portion 222. The first tail portion 222 of the first ground terminal G1 and the first tail portion 222 of the second ground terminal G2 are both provided with fisheye holes, so that they have a certain elastic deformation ability, so that the first tail portion 222 of the first ground terminal G1 can be inserted into the first ground terminal mounting hole 3013 along an installation direction (third direction A3-A3), and the first tail portion 222 of the second ground terminal G2 can be inserted into the second ground terminal mounting hole 3014 along the installation direction.

The first tail portion 222 of the first signal terminal S1 includes a first serpentine portion 2221 and a first distal portion 2222 further extending from the first serpentine portion 2221 along the installation direction.

Similarly, the first tail portion 222 of the second signal terminal S2 includes a second serpentine portion 2223 and a second distal portion 2224 further extending from the second serpentine portion 2223 along the installation direction.

In the second embodiment of the first backplane connector 100 of the present disclosure, the first backplane connector 100 further includes a mounting block 2225 fixed on the first tail portion 222 of the first signal terminal S1 and the first tail portion 222 of the second signal terminal S2, so as to form the first differential signal terminals as a whole.

Referring to FIG. 66 to FIG. 68, the first serpentine portion 2221 includes a plurality of first units 2221a, a plurality of second units 2221b, and a plurality of third units 2221c. The first unit 2221a, the second unit 2221b and the third unit 2221c are connected in sequence. In the illustrated embodiment of the present disclosure, the first unit 2221a, the second unit 2221b and the third unit 2221c are all H-shaped.

The first unit 2221a includes a first transverse beam portion 2221a1, a first longitudinal beam portion 2221a2 located at one end of the first transverse beam portion 2221a1, and a second longitudinal beam portion 2221a3 located at another end of the first transverse beam portion 2221a1. Both ends of the first longitudinal beam portion 2221a2 and the second longitudinal beam portion 2221a3 respectively extend upward and downward along the installation direction and protrude beyond the first transverse beam portion 2221a1. In other words, the first unit 2221a includes a U-shaped first recessed opening 2221a4 located at an upper portion of the first transverse beam portion 2221a1 and a U-shaped second recessed opening 2221a5 located at a lower portion of the first transverse beam portion 2221a1.

Similarly, the second unit 2221b includes a second transverse beam portion 2221b1, a third longitudinal beam portion 2221b2 located at one end of the second transverse beam portion 2221b1, and a fourth longitudinal beam portion 2221b3 located at another end of the second transverse beam portion 2221b1. Both ends of the third longitudinal beam portion 2221b2 and the fourth longitudinal beam portion 2221b3 respectively extend upward and downward along the installation direction and protrude beyond the second transverse beam portion 2221b1. In other words, the second unit 2221b includes a U-shaped third recessed opening 2221b4 located at an upper portion of the second transverse beam portion 2221b1 and a U-shaped fourth recessed opening 2221b5 located at a lower portion of the second transverse beam portion 2221b1.

The third unit 2221c includes a third transverse beam portion 2221c1, a fifth longitudinal beam portion 2221c2 located at one end of the third transverse beam portion 2221c1, and a sixth longitudinal beam portion 2221c3 located at another end of the third transverse beam portion 2221c1. Both ends of the fifth longitudinal beam portion 2221c2 and the sixth longitudinal beam portion 2221c3 respectively extend upward and downward along the installation direction and protrude beyond the third transverse beam portion 2221c1. In other words, the third unit 2221c includes a U-shaped fifth recessed opening 2221c4 located at an upper portion of the third transverse beam portion 2221c1 and a U-shaped sixth recessed opening 2221c5 located at a lower portion of the third transverse beam portion 2221c1.

In the illustrated embodiment of the present disclosure, the first transverse beam portion 2221a1, the second transverse beam portion 2221b1 and the third transverse beam portion 2221c1 are sequentially disposed along the installation direction. The first longitudinal beam portion 2221a2, the third longitudinal beam portion 2221b2 and the fifth longitudinal beam portion 2221c2 are sequentially disposed along the installation direction. The second longitudinal beam portion 2221a3, the fourth longitudinal beam portion 2221b3 and the sixth longitudinal beam portion 2221c3 are sequentially disposed along the installation direction. The second longitudinal beam portion 2221a3 is connected to the fourth longitudinal beam portion 2221b3. The third longitudinal beam portion 2221b2 is connected to the fifth longitudinal beam portion 2221c2. The second recessed opening 2221a5 is in communication with the third recessed opening 2221b4. The fourth recessed opening 2221b5 is in communication with the fifth recessed opening 2221c4. When the first tail portion 222 of the first signal terminal S1 is not mounted to the circuit board 301, the first serpentine portion 2221 includes a first slit 2221d1 located between the first longitudinal beam portion 2221a2 and the third longitudinal beam portion 2221b2, and a second slit 2221d2 located between the fourth longitudinal beam portion 2221b3 and the sixth longitudinal beam portion 2221c3. The first slit 2221d1 and the second slit 2221d2 are disposed sequentially along the installation direction, and are arranged staggered along the installation direction.

The second serpentine portion 2223 and the first serpentine portion 2221 are disposed symmetrically (for example, left-right symmetrically), which will not be described in detail in the present disclosure.

In the illustrated embodiment of the present disclosure, both the first distal portion 2222 and the second distal portion 2224 are triangular and have a solid structure. When the first tail portion 222 of the first signal terminal S1 and the first tail portion 222 of the second signal terminal S2 are mounted in the first signal terminal mounting hole 3011 and the second signal terminal mounting hole 3012, respectively, along the installation direction, the first distal portion 2222 and the second distal portion 2224 are at least partially inserted into the first signal terminal mounting hole 3011 and the second signal terminal mounting hole 3012, respectively, along the installation direction, so as to achieve electrical connection with the circuit board 301. Since the lengths of the first distal portion 2222 and the second distal portion 2224 are shorter, during the process of mounting the first tail portion 222 of the first signal terminal S1 and the first tail portion 222 of the second signal terminal S2 in the first signal terminal mounting hole 3011 and the second signal terminal mounting hole 3012, respectively, along the installation direction, the first serpentine portion 2221 of the first signal terminal S1 and the second serpentine portion 2223 of the second signal terminal S2 are subjected to an reaction force of the circuit board 301 and undergo a certain elastic compression along the installation direction. The forward force is controlled to prevent the first serpentine portion 2221 of the first signal terminal S1 and the second serpentine portion 2223 of the second signal terminal S2 from being overly compressed. Preferably, the first slit 2221d1 and the second slit 2221d2 are zero. That is, the first longitudinal beam portion 2221a2 and the third longitudinal beam portion 2221b2 are in contact with each other along the installation direction; and the fourth longitudinal beam portion 2221b3 and the sixth longitudinal beam portion 2221c3 are in contact with each other along the installation direction, so as to reduce signal flow paths. With this arrangement, when the first tail portion 222 of the first signal terminal S1 is transmitting a signal, the signal can be transmitted through the following parallel paths:
path 1: the first longitudinal beam portion 2221a2→the third longitudinal beam portion 2221b2→the fifth longitudinal beam portion 2221c2→ . . . →the first distal portion 2222→the circuit board 301;
path 2: the second longitudinal beam portion 2221a3→the fourth longitudinal beam portion 2221b3→the sixth longitudinal beam portion 2221c3→ . . . →the first distal portion 2222→the circuit board 301.

It is understandable to those skilled in the art that in the illustrated embodiment of the present disclosure, the first tail portion 222 of the first ground terminal G1 and the first tail portion 222 of the second ground terminal G2 both extend downwardly beyond the first distal portion 2222 and the second distal portion 2224. Although the first distal portion 2222 and the second distal portion 2224 are short in length and inelastic, the first tail portion 222 of the first ground terminal G1 and the first tail portion 222 of the second ground terminal G2 are relatively longer and elastic. When the first tail portion 222 of the first ground terminal G1 and the first tail portion 222 of the second ground terminal G2 are respectively inserted into the first ground terminal mounting hole 3013 and the second ground terminal mounting hole 3014, the first tail portion 222 of the first ground terminal G1 and the first tail portion 222 of the second ground terminal G2 are interference-fitted with the first ground terminal mounting hole 3013 and the second ground terminal mounting hole 3014, respectively. The interference force thus generated can maintain the first distal portion 2222 of the first signal terminal S1 and the second distal portion 2224 of the second signal terminal S2 in the first signal terminal mounting hole 3011 and the second signal terminal mounting hole 3012, respectively. At the same time, the first distal portion 2222 of the first signal terminal S1 and the second distal portion 2224 of the second signal terminal S2 can be designed to be shorter to reduce installation difficulty and improve signal transmission quality.

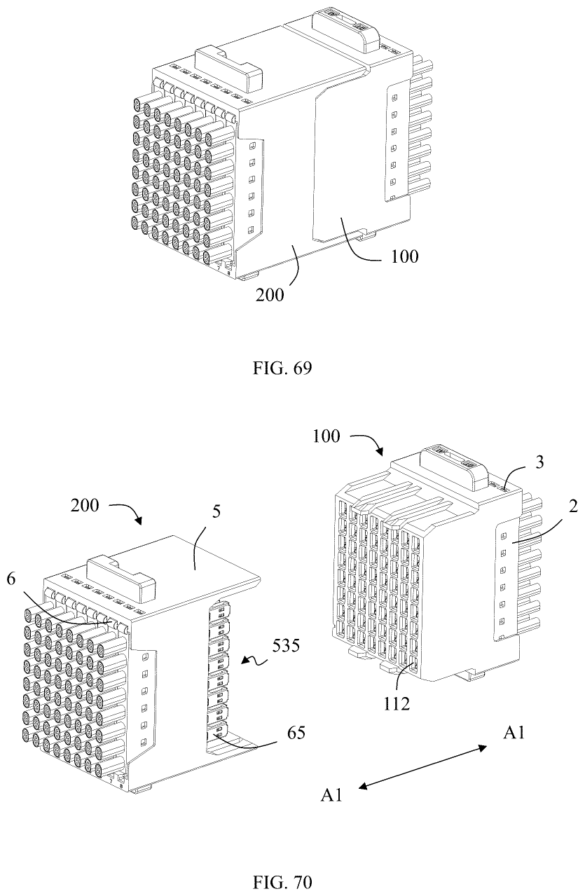

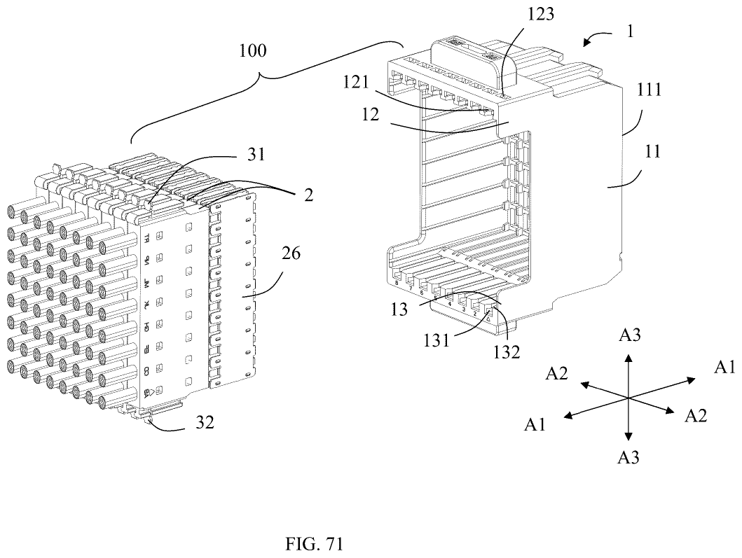

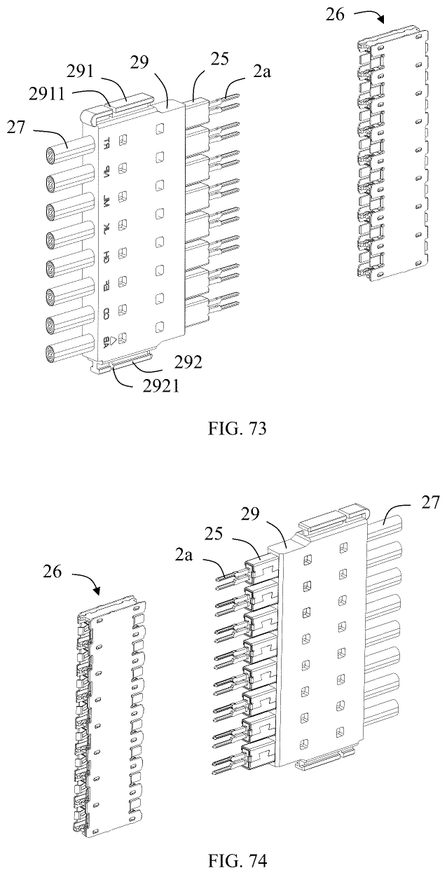

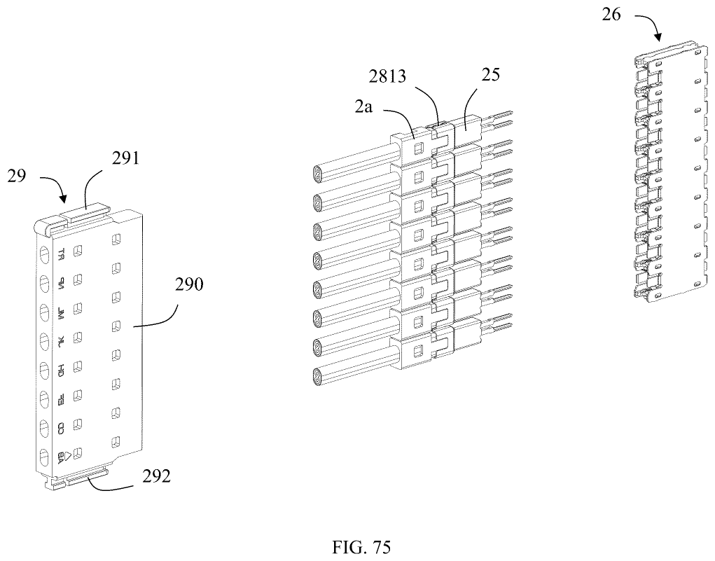

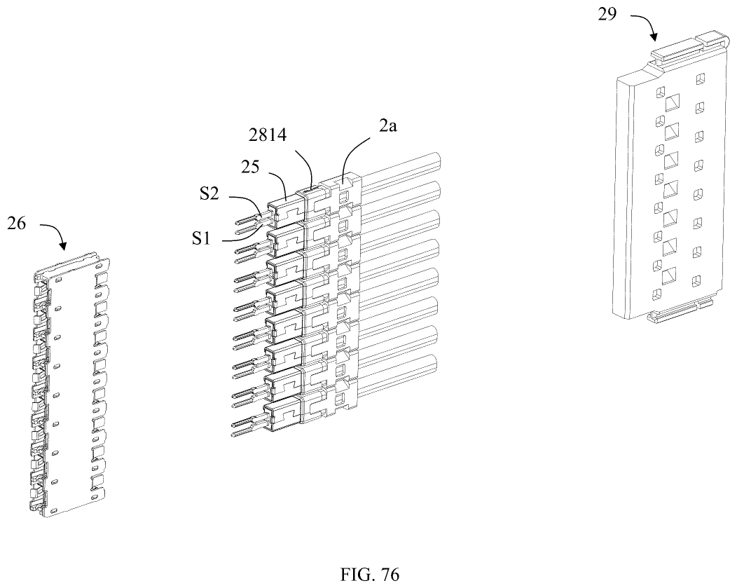

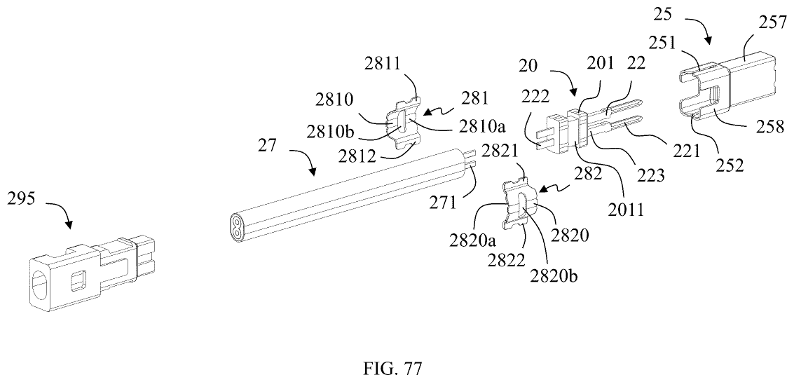

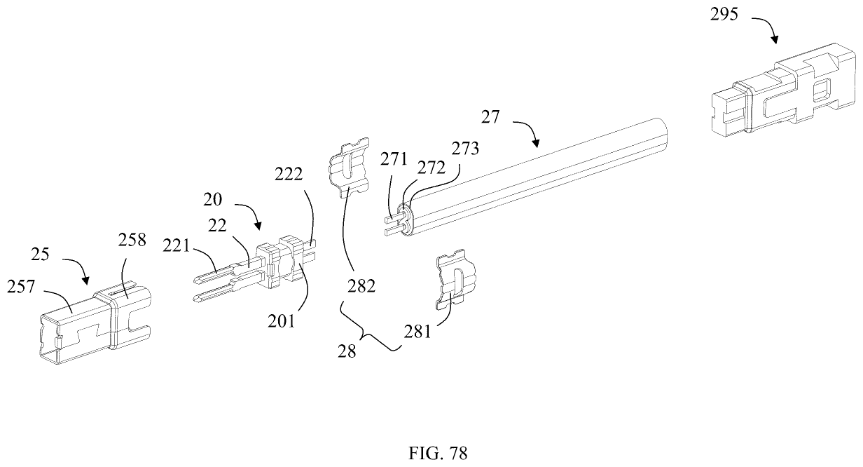

Referring to FIG. 69 to FIG. 78, a third embodiment of the present disclosure discloses a backplane connector assembly, which includes a first backplane connector 100 and a second backplane connector 200 for mating with the first backplane connector 100. In the third embodiment of the present disclosure, the first backplane connector 100 and the second backplane connector 200 are both cable backplane connectors. In the third embodiment illustrated in the present disclosure, the first backplane connector 100 and the second backplane connector 200 are mated in along a first direction A1-A1 (a mating direction) to achieve signal transmission. In the third embodiment illustrated in the present disclosure, the first direction A1-A1 is a front-back direction.

The first backplane connector 100 includes a first housing 1, a plurality of first terminal modules 2 mounted to the first housing 1, and a first positioning pin piece 3 configured to position the first terminal modules 2 to the first housing 1. In order to simplify the description, in the first backplane connector 100 in the third embodiment of the present disclosure and the first backplane connector 100 in the first embodiment of the present disclosure, the same reference numerals represent the same or corresponding features. In addition, the second backplane connector 200 in the third embodiment of the present disclosure is the same as the second backplane connector 200 in the first embodiment of the present disclosure, which will not be described again in the disclosure.

Referring to FIG. 70 to FIG. 72, in the third embodiment of the present disclosure, the first housing 1 is made of insulating material and includes a first body portion 11, a first wall portion 12 extending backwardly from one end (for example, an upper end) of the first body portion 11, and a second wall portion 13 extending backwardly from another end (for example, a lower end) of the first body portion 11. The first body portion 11 includes a mating surface 111 and a plurality of terminal receiving grooves 112 extending through the mating surface 111. In the illustrated embodiment of the present disclosure, the terminal receiving grooves 112 are disposed in multiple rows along the third direction A3-A3. The first wall portion 12 defines a plurality of first insertion slots 121 and a plurality of first locking grooves 123 communicating with the first insertion slots 121. In the illustrated embodiment of the present disclosure, the first locking grooves 123 extend through the first wall portion 12 in the top-bottom direction. The second wall portion 13 defines a plurality of second insertion slots 131 and a plurality of second locking grooves 133 communicating with the second insertion slots 131. In the illustrated embodiment of the present disclosure, the second locking grooves 133 extend through the second wall portion 13 in the top-bottom direction. The first insertion slots 121 and the second slots 131 both extend along the first direction A1-A1. The first insertion slot 121 and the second slot 131 which are aligned with each other in the top-bottom direction are used together to receive a corresponding first terminal module 2.

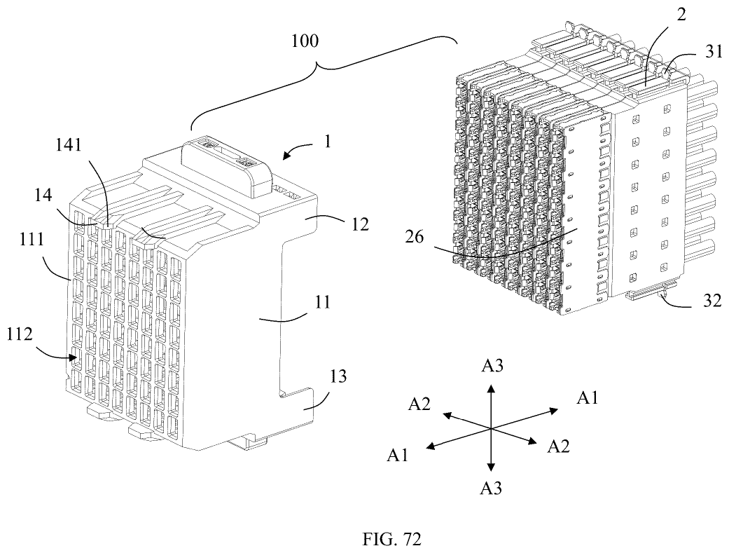

Besides, referring to FIG. 72, the first housing 1 further includes a plurality of positioning protrusions 14 extending forwardly from the first wall portion 12 and the second wall portion 13, respectively, and protruding beyond the mating surface 111. Each positioning protrusion 14 includes a guide inclined surface 141 at an end thereof. The positioning protrusion 14 is configured to be inserted into a positioning groove 536 of the second backplane connector 200.

Each first terminal module 2 includes a plurality of first cable modules 2a spaced apart along the third direction A3-A3, a plurality of first shielding sleeves 25 sleeved on the first cable modules 2a, a first fixing block 29 fixed on the plurality of first cable modules 2a and the first shielding sleeves 25, and an extension shielding shell assembly 26 mating with the first shielding sleeves 25. In one embodiment of the present disclosure, the first fixing block 29 is made of insulating material, and is over-molded on the plurality of first cable modules 2a and the plurality of first shielding sleeves 25, so as to be combined with the plurality of first cable modules 2a and the plurality of first shielding sleeves 25 as a whole. In the illustrated embodiment of the present disclosure, the first fixing block 29 is embedded in a slot of the first cable module 2a during molding to increase the bonding force therebetween. Of course, it is understandable to those skilled in the art that the plurality of first cable modules 2a can also be fixed to the first fixing block 29 through assembly or other methods, which will not be described in detail in the present disclosure.

The first fixing block 29 includes a first base portion 290, a first positioning block 291 protruding upwardly from the top of the first base portion 290, and a second positioning block 292 protruding downward from the bottom of the first base portion 290. The first positioning block 291 is configured to be inserted into the first insertion slot 121. The first positioning block 291 defines a first notch 2911 that communicates with the first locking groove 123 in the top-bottom direction. The second positioning block 292 is configured to be inserted into the second insertion slot 131. The second positioning block 292 defines a second notch 2921 that communicates with the second locking groove 133 in the top-bottom direction.

In an embodiment of the present disclosure, the first positioning pin piece 3 includes a plurality of first pins 31 and a plurality of second pins 32. The first pins 31 and the second pins 32 are stamped from metal sheets. In an embodiment of the present disclosure, the plurality of first pins 31 can be provided separately. The first pin 31 is installed in the corresponding first locking groove 123 and the first notch 2911. The plurality of second pins 32 can be provided separately. The second pin 32 is installed in the corresponding second locking groove 133 and the second notch 2921. Of course, in other embodiments of the present disclosure, the plurality of first pins 31 can also be connected as a whole through a first material strip (not shown). The plurality of second pins 32 can also be connected as a whole through a second material strip (not shown). During assembly, the first pins 31 and the second pins 32 are integrally installed in the corresponding first locking grooves 123 and the first notches 2911, and the second locking grooves 133 and the second notches 2921, respectively, to improve the assembly efficiency. After the assembly is completed, the first material strip and the second material strip can be removed or retained according to actual needs. By fixing the first terminal modules 2 with the first pins 31 and the second pins 32, it is possible to prevent the first terminal modules 2 from being detached from the first housing 1 in a direction opposite to its assembly direction. In addition, this design saves space because the first pins 31 and the second pins 32 can be hidden in the first housing 1, which reduces the size of the first backplane connector 100 to a certain extent, and reduces the probability that the first pins 31 and the second pins 32 lose their limiting function due to improper external forces.

In the illustrated embodiment of the present disclosure, each first cable module 2a includes a first terminal module 20, a plurality of first cables 27 electrically connected to the first terminal module 20, a first shielding clamp 28 mating with the first cable 27, and a first over-molding block 295 at least partially fixed on the first terminal module 20, the first shielding clamp 28 and the first cables 27.

In the illustrated embodiment of the present disclosure, the first terminal module 20 includes a first holding block 201 and a plurality of first conductive terminals 22 fixed to the first holding block 201. In one embodiment of the present disclosure, the first holding block 201 is made of insulating material, and the first conductive terminals 22 are insert-molded with the first holding block 201. Of course, in other embodiments, the first conductive terminals 22 can also be fixed to the first holding block 201 through assembly. In the illustrated embodiment of the present disclosure, the first holding block 201 includes a first slot 2011 which extends along a circumferential direction of the first holding block 201.

Each group of first conductive terminals 22 includes a first contact portion 221, a first tail portion 222, and a first connection portion 223 connecting the first contact portion 221 and the first tail portion 222. The first connection portion 223 is at least partially fixed in the first holding block 201. The first contact portion 221 is needle-shaped and protrudes forwardly beyond the first holding block 201 to mate with the second backplane connector 200. The first tail portion 222 protrudes backwardly beyond the first holding block 201 to be electrically connected to the first cable 27. In the illustrated embodiment of the present disclosure, each first conductive terminal 22 is substantially straight and extends in the front-back direction.

In an embodiment of the present disclosure, the first conductive terminals 22 in each first terminal module 20 include a first signal terminal S1 and a second signal terminal S2. The first signal terminal S1 and the second signal terminal S2 form a pair of first differential signal terminals to increase the signal transmission rate. The first cable 27 includes a first core 271 for electrically connecting with the first tail portion 222 of the first differential signal terminals, a first insulating layer 272 wrapped around the first core 271, and a first shielding layer 273 located on an outer layer of the first insulating layer 272. In an embodiment of the present disclosure, the first core 271 and the first tail portion 222 of the first differential signal terminals are fixed by soldering or welding. In the illustrated embodiment of the disclosure, the first shielding layer 273 is in contact with the first shielding clamp 28.

In the illustrated embodiment of the present disclosure, the first shielding clamp 28 is made of metal material. The first shielding clamp 28 includes a first clamping plate portion 281 and a second clamping plate portion 282. The first clamping plate portion 281 and the second clamping plate portion 282 are clamped and fixed on the first cable 27. The first clamping plate portion 281 and the second clamping plate portion 282 are both in contact with the first shielding layer 273. In the illustrated embodiment of the present disclosure, the first shielding layer 273 is sandwiched by the first clamping plate portion 281 and the second clamping plate portion 282.

Of course, it is understandable to those skilled in the art that the first cable 27 can be a cable having a single ground wire, a double ground wire or no ground wire in the prior art. When the first cable 27 adopts the cable having the single ground wire or the double ground wire, the ground wire is configured to be in contact with the first shielding clamp 28 to achieve ground conduction. When the first cable 27 is a cable without the ground wire, the first cable 27 is provided with a shielding layer which is configured to be in contact with the first shielding clamp 28 to achieve ground conduction.

In the illustrated embodiment of the present disclosure, the first clamping plate portion 281 includes a first clamping portion 2810, a first tab portion 2811 extending from a top end of the first clamping portion 2810, and a second tab portion 2812 extending from a bottom end of the first clamping portion 2810. The first clamping portion 2810 has an arc-shaped first inner surface 2810a and a first opening 2810b extending through the first clamping portion 2810.

The second clamping plate portion 282 includes a second clamping portion 2820, a third tab portion 2821 extending from a top end of the second clamping portion 2820, and a fourth tab portion 2822 extending from a bottom end of the second clamping portion 2820. The second clamping portion 2820 has an arc-shaped second inner surface 2820a and a second opening 2820b extending through the second clamping portion 2820.

The first clamping portion 2810 and the second clamping portion 2820 jointly clamp the first cable 27. The first opening 2810b and the second opening 2820b can be filled with solder, so that the first shielding clamp 28 and the first shielding layer 273 can be easily soldered.

In the illustrated embodiment of the present disclosure, the first tab portion 2811 and the third tab portion 2821 abut against each other to form a first insertion tab 2813. The second tab portion 2812 and the fourth tab portion 2822 abut against each other to form a second insertion tab 2814. The first insertion tab 2813 and the second insertion tab 2814 are both in contact with the first shielding sleeve 25.

In an embodiment of the present disclosure, the first over-molding block 295 is over-molded on the first terminal modules 20, the first shielding clamps 28 and the first cables 27, so as to be integrated with the first terminal modules 20, the first shielding clamps 28 and the first cables 27. Specifically, the first over-molding block 295 is embedded in the first slot 2011 of the first holding block 201 to improve the combination reliability thereof. The first insertion tab 2813 and the second insertion tab 2814 extend upward and downward respectively and protrude beyond the first over-molding block 295.

In the illustrated embodiment of the present disclosure, the first shielding sleeve 25 includes a cylindrical portion 257 at least partially sleeved on the first over-molding block 295 and a sleeve portion 258 connected to the cylindrical portion 257. The sleeve portion 258 defines a first clamping slot 251 and a second clamping slot 252. In the illustrated embodiment of the present disclosure, the first clamping slot 251 is configured for insertion of the first insertion tab 2813, and the second clamping slot 252 is configured for insertion of the second insertion tab 2814.

It is understandable to those skilled in the art that in the illustrated embodiment of the present disclosure, the first shielding layer 273 is in contact with the first shielding clamp 28, and the first shielding clamp 28 is in contact with the first shielding sleeve 25. With this arrangement, the first shielding layer 273, the first shielding clamp 28 and the first shielding sleeve 25 are connected in series to form a ground shielding structure, thereby improving the quality of signal transmission.

The extension shielding shell assembly 26 of the first backplane connector 100 in the third embodiment of the present disclosure is exactly the same as the extension shielding shell assembly 26 of the first backplane connector 100 in the first embodiment of the present disclosure, which will not be described in detail in the present disclosure. It is understandable to those skilled in the art that designing the extension shielding shell assembly 26 in the form of the present disclosure can share parts as much as possible, regardless of whether the first backplane connector 100 is a board-end back plane connector in the first embodiment or the cable backplane connector in the third embodiment.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A first terminal module, comprising:
a first cable module, the first cable module comprising a plurality of first conductive terminals and a first cable connected to the first conductive terminals; the first conductive terminals comprising a first signal terminal and a second signal terminal; each of the first signal terminal and the second signal terminal comprising a first contact portion; and
an extension shielding shell assembly, the extension shielding shell assembly comprising:
a first extension shielding piece;
a second extension shielding piece disposed opposite to the first extension shielding piece;
a first connection shielding piece;
a second connection shielding piece disposed opposite to the first connection shielding piece; and
at least one elastic piece, the at least one elastic piece being fixed to at least one of the first extension shielding piece, the second extension shielding piece, the first connection shielding piece and the second connection shielding piece;
wherein the first extension shielding piece, the second extension shielding piece, the first connection shielding piece and the second connection shielding piece jointly form a shielding chamber; the first contact portion of the first signal terminal and the first contact portion of the second signal terminal protrudes into the shielding cavity of the extension shielding shell assembly;
the elastic piece protrudes into the shielding chamber.

2. The first terminal module according to claim 1, further comprising a first shielding sleeve at least partially sleeved on the first cable module, and the at least one elastic piece being in contact with the first shielding sleeve.

3. The first terminal module according to claim 2, wherein the extension shielding shell assembly comprises a first elastic piece; the first elastic piece and the first connection shielding piece are provided separately; the first elastic piece comprises a first fixing portion fixed to the first connection shielding piece, a first elastic arm extending from one end of the first fixing portion, and a second elastic arm extending from another end of the first fixing portion; the first elastic arm and the second elastic arm are configured to abut against a second backplane connector.

4. The first terminal module according to claim 3, wherein the at least one elastic piece comprises a second elastic piece; the second elastic piece and the first connection shielding piece are provided separately; the second elastic piece comprises a second fixing portion fixed to the first connection shielding piece, a third elastic arm extending from one end of the second fixing portion, and a fourth elastic arm extending from another end of the second fixing portion; the third elastic arm and the fourth elastic arm protrude into the shielding chamber to abut against the first shielding sleeve.

5. The first terminal module according to claim 4, wherein the first elastic arm, the second elastic arm, the third elastic arm and the fourth elastic arm are disposed sequentially along a mating direction.

6. The first terminal module according to claim 2, wherein the extension shielding shell assembly comprises a third elastic piece; the third elastic piece and the second connection shielding piece are provided separately; the third elastic piece comprises a third fixing portion fixed to the second connection shielding piece, a fifth elastic arm extending from one end of the third fixing portion, and a sixth elastic arm extending from another end of the third fixing portion; the fifth elastic arm and the sixth elastic arm are configured to abut against a second backplane connector.

7. The first terminal module according to claim 6, wherein the extension shielding shell assembly comprises a fourth elastic piece; the fourth elastic piece and the second connection shielding piece are provided separately; the fourth elastic piece comprises a fourth fixing portion fixed to the second connection shielding piece, a seventh elastic arm extending from one end of the fourth fixing portion, and an eighth elastic arm extending from another end of the fourth fixing portion; the seventh elastic arm and the eighth elastic arm protrude into the shielding chamber to abut against the first shielding sleeve.

8. The first terminal module according to claim 7, wherein the fifth elastic arm, the sixth elastic arm, the seventh elastic arm and the eighth elastic arm are disposed sequentially along a mating direction.

9. The first terminal module according to claim 1, wherein the extension shielding shell assembly comprises a first abutting elastic piece; the first abutting elastic piece and the first extension shielding piece are provided separately; the first abutting elastic piece comprises a first holding portion fixed to the first extension shielding piece, a first abutting elastic arm extending from one end of the first holding portion, and a second abutting elastic arm extending from another end of the first holding portion; the first abutting elastic arm and the second abutting elastic arm are configured to abut against a second backplane connector.

10. A first backplane connector, comprising:
a first housing; and
a first terminal module mounted to the first housing; the first terminal module comprising:
a first cable module, the first cable module comprising a plurality of first conductive terminals and a first cable connected to the first conductive terminals; the first conductive terminals comprising a first signal terminal and a second signal terminal; each of the first signal terminal and the second signal terminal comprising a first contact portion; and
an extension shielding shell assembly, the extension shielding shell assembly comprising:
a first extension shielding piece;
a second extension shielding piece disposed opposite to the first extension shielding piece;
a first connection shielding piece;
a second connection shielding piece disposed opposite to the first connection shielding piece; and
at least one elastic piece, the at least one elastic piece being fixed to at least one of the first extension shielding piece, the second extension shielding piece, the first connection shielding piece and the second connection shielding piece;
wherein the first extension shielding piece, the second extension shielding piece, the first connection shielding piece and the second connection shielding piece jointly form a shielding chamber; the first contact portion of the first signal terminal and the first contact portion of the second signal terminal protrudes into the shielding cavity of the extension shielding shell assembly;
the elastic piece protrudes into the shielding chamber.

11. The first backplane connector according to claim 10, wherein the first terminal module further comprises a first shielding sleeve at least partially sleeved on the first cable module, and the at least one elastic piece is in contact with the first shielding sleeve.

12. The first backplane connector according to claim 11, wherein the extension shielding shell assembly comprises a first elastic piece; the first elastic piece and the first connection shielding piece are provided separately; the first elastic piece comprises a first fixing portion fixed to the first connection shielding piece, a first elastic arm extending from one end of the first fixing portion, and a second elastic arm extending from another end of the first fixing portion; the first elastic arm and the second elastic arm are configured to abut against a second backplane connector.

13. The first backplane connector according to claim 12, wherein the at least one elastic piece comprises a second elastic piece; the second elastic piece and the first connection shielding piece are provided separately; the second elastic piece comprises a second fixing portion fixed to the first connection shielding piece, a third elastic arm extending from one end of the second fixing portion, and a fourth elastic arm extending from another end of the second fixing portion; the third elastic arm and the fourth elastic arm protrude into the shielding chamber to abut against the first shielding sleeve.

14. The first backplane connector according to claim 13, wherein the first elastic arm, the second elastic arm, the third elastic arm and the fourth elastic arm are disposed sequentially along a mating direction.

15. The first backplane connector according to claim 11, wherein the extension shielding shell assembly comprises a third elastic piece; the third elastic piece and the second connection shielding piece are provided separately; the third elastic piece comprises a third fixing portion fixed to the second connection shielding piece, a fifth elastic arm extending from one end of the third fixing portion, and a sixth elastic arm extending from another end of the third fixing portion; the fifth elastic arm and the sixth elastic arm are configured to abut against a second backplane connector.

16. The first backplane connector according to claim 15, wherein the extension shielding shell assembly comprises a fourth elastic piece; the fourth elastic piece and the second connection shielding piece are provided separately; the fourth elastic piece comprises a fourth fixing portion fixed to the second connection shielding piece, a seventh elastic arm extending from one end of the fourth fixing portion, and an eighth elastic arm extending from another end of the fourth fixing portion; the seventh elastic arm and the eighth elastic arm protrude into the shielding chamber to abut against the first shielding sleeve.

17. The first backplane connector according to claim 16, wherein the fifth elastic arm, the sixth elastic arm, the seventh elastic arm and the eighth elastic arm are disposed sequentially along a mating direction.

18. The first backplane connector according to claim 10, wherein the extension shielding shell assembly comprises a first abutting elastic piece; the first abutting elastic piece and the first extension shielding piece are provided separately; the first abutting elastic piece comprises a first holding portion fixed to the first extension shielding piece, a first abutting elastic arm extending from one end of the first holding portion, and a second abutting elastic arm extending from another end of the first holding portion; the first abutting elastic arm and the second abutting elastic arm are configured to abut against a second backplane connector.
